(19) United States
(12) Patent Application Publication
(10) Pub. No.: US 2013/0080227 A1
(43) Pub. Date: Mar. 28, 2013

(54) SYSTEM AND METHOD FOR PREDICTIVE ACCRUAL OF CREDITS IN A VARIABLE VALUE TRANSACTION

(71) Applicant: Redbox Automated Retail, LLC, Oakbrook Terrace, IL (US)

(72) Inventors: Imran Maskatia, Milpitas, CA (US); Michael Papasevastos, Elgin, IL (US); Saad Rehmani, Glen Ellyn, IL (US); Jason Rubinstein, Lake Forest, IL (US); Heidemarie Williams, Homer Glen, IL (US)

(73) Assignee: Redbox Automated Retail, LLC, Oakbrook Terrace, IL (US)

(21) Appl. No.: 13/623,072

(22) Filed: Sep. 19, 2012

Related U.S. Application Data
(60) Provisional application No. 61/538,900, filed on Sep. 25, 2011.

(51) Int. Cl. G06Q 30/02

(52) U.S. Cl. 705/14.23

(57) ABSTRACT

A system and method of predicatively accruing a credit in a variable value transaction are provided. The variable value transaction may involve a piece of media content and include an initial balance and a remaining balance. The initial balance and the remaining balance may be dependent on the piece of media content and when the variable value transaction is completed. Credits may be accrued for a predicted redemption of the credit for the remaining balance, depending on the availability and applicability of the credits. A payment card may also be processed for some or all of the remaining balance. The remaining balance may not be known until the variable value transaction is completed. A pending revenue amount may be determined based on the accrual of the credits.

### CROSS-REFERENCE TO RELATED APPLICATIONS

This application claims priority to U.S. Provisional Application No. 61/538,900, filed Sep. 25, 2011, entitled “SYSTEM AND METHOD FOR PREDICTIVE ACCRUAL OF CREDITS IN A VARIABLE VALUE TRANSACTION”, and is incorporated herein by reference in its entirety.

This application is being filed simultaneously with U.S. patent application Ser. No. ______, entitled “SYSTEM AND METHOD FOR REDEMPTION OF CREDITS IN A VARIABLE VALUE TRANSACTION”, Attorney Docket No. 19638.23US2; U.S. patent application Ser. No. ______, entitled “SYSTEM AND METHOD FOR OPTIMIZED REDEMPTION OF CREDITS IN A VARIABLE VALUE TRANSACTION”, Attorney Docket No. 19638.25US2; U.S. patent application Ser. No. ______, entitled “SYSTEM AND METHOD FOR MANAGEMENT OF CREDIT SUBSCRIPTIONS”, Attorney Docket No. 19638.26US2; and U.S. patent application Ser. No. ______, entitled SYSTEM AND METHOD FOR CURRENCY CONVERSION RELATED TO CREDITS REDEEMABLE IN A VARIABLE VALUE TRANSACTION, Attorney Docket No. 19638.27US2 all which are incorporated herein by reference in their entirety.

### TECHNICAL FIELD

This invention relates to a system and method for predictive accrual of credits in a variable value transaction. More particularly, the present invention provides a system and method for predicatively accruing credits to satisfy a remaining balance of a variable value transaction.

### BACKGROUND AND SUMMARY OF THE INVENTION

While the present invention is often described herein with reference to a digital video disc, Blu-Ray disc, and video game distribution system, an application to which the present invention is advantageously suited, it will be readily apparent that the present invention is not limited to that application and can be employed in article dispensing systems used to distribute a wide variety of dispensable articles.

The digital video disc (DVD) player has been one of the most successful consumer electronics product launches in history. The market for DVD movie video, Blu-Ray movie video, and video game rentals is enormous and growing. Millions of households have acquired DVDs since they were introduced in 1997. In the first quarter of 2003 alone, it was estimated that well over three million DVD players were shipped to U.S. retailers.

In 2003, brick-and-mortar stores dominated the movie video and video game rental landscape in the U.S. Statistics showed that two brick-and-mortar companies controlled nearly sixty-five percent of the home video rental business. One element repeatedly cited for success of certain brick-and mortar store video rental franchises was perceived high availability of new video releases. Consumers want entertainment on demand, and through stocking multiple units of each new release, successful brick-and-mortar companies meet this consumer demand.

The foregoing indicates that there is a significant market potential for aligning regular routines of consumers (e.g., shopping, getting coffee, gas, or going to a convenience store) with their DVD, Blu-Ray, and video game rental activities.

One improved article dispensing machine is disclosed in commonly owned U.S. Pat. No. 7,234,609, which is herein incorporated by reference in its entirety. The invention of the U.S. Pat. No. 7,234,609 and the present invention can function as an article dispensing machine-based distribution system that will typically have multiple units of each new release per article dispensing machine. The dispensing machines of the U.S. Pat. No. 7,234,609 and the present invention can stock up to two thousand DVDs, Blu-Ray, video games, or other discs (movies, games or other entertainment content), making the system competitive with existing brick-and-mortar video rental superstores.

The dispensing machine and system of the U.S. Pat. No. 7,234,609 and the present invention distinguishes itself from such stores by offering major benefits not conventionally offered by such stores, including additional cross-marketing programs (e.g., promotional rentals for a certain amount of dollars spent at the retail location) and convenience (e.g., open always).

The dispensing machine of the U.S. Pat. No. 7,234,609 and the present invention yields a competitive advantage in the DVD, Blu-Ray disc, and video game rental marketplace by offering consumers cross-marketing/promotional programs, convenience of selection (e.g., computer-based searches for movies and recommendations based on consumer profiles), and potentially extended hours (e.g., 24 hours a day, 7 days a week). The present invention employs a more cost-effective, convenient platform than brick-and-mortar stores. In addition, with the present invention, dispensing machines can be situated in retail locations having high foot traffic, such as at a popular grocery store, restaurant, drug store, and/or other popular retail location.

The dispensing machine of the U.S. Pat. No. 7,234,609 and the present invention can be operated at a substantial savings over the costs associated with traditional brick-and-mortar video rental stores. For example, the present invention does not require hourly employees manning the dispensing machines or restocking them with inventories, due to the ability of the article transport storage units to be delivered to/picked up from retail locations by third-party delivery services, such as traditional or contracted courier services.

Unlike brick-and-mortar stores, the dispensing machine of the U.S. Pat. No. 7,234,609 and the present invention does not require an on-site store manager because all operational decisions can be made at a centralized location by a management team officed remote from the retail locations. Unlike brick-and-mortar stores, the dispensing machine of the U.S. Pat. No. 7,234,609 and the present invention does not require significant physical space. Unlike brick-and-mortar stores, the dispensing machine of the U.S. Pat. No. 7,234,609 and the present invention has low operating costs because heating or air conditioning is not necessarily required for the dispensing machines and they consume a relatively low level of electrical energy. In addition, the dispensing machine of the U.S. Pat. No. 7,234,609 has low maintenance costs and downtime.

The dispensing machine of the U.S. Pat. No. 7,234,609 and the present invention addresses the shortcomings of traditional brick-and-mortar stores in a convenient and cost-effective delivery vehicle having the added bonus of serving as an effective promotional platform that drives incremental sales to retail locations. In addition, the dispensing machine of the U.S. Pat. No. 7,234,609 and the present invention overcomes these disadvantages by at least offering more new releases and older selections for any given time period, and lower cost per viewing with significantly more convenience than Internet-based and pay-per-view services.

The dispensing machine of the U.S. Pat. No. 7,234,609 and the present invention is a fully automated, integrated DVD, Blu-Ray, and video game rental and/or purchase systems. It preferably incorporates robust, secure, scalable software that provides a fully personalized user experience and real-time feedback to retail locations and advertisers, scalable hardware that leverages existing technologies such as touch screen, focused audio speakers and video monitors, technology utilizing the Internet through a system website or mobile/consumer electronics device application, and an article transport storage unit that facilitates the exchange of new discs for old discs in each machine with virtually no need for human intervention. These technologies and others fill long-felt needs in the art and give advantages over conventional video distribution options. The dispensing machine of the U.S. Pat. No. 7,234,609 and the present invention functions as much as a promotional platform as it does a rental kiosk.

By utilizing the dispensing machines and the fully-interactive, real-time, linked Internet website or mobile/consumer electronics device applications, consumers can rent one or more DVDs, Blu-Ray discs, video games, or other entertainment content directly from dispensing machines as well as indirectly by making a rental reservation through the website or application for later pickup at a conveniently located machine. These dispensing machines are preferably networked with each other, with the inventory control and/or supply office and with the system website or application by phone-line, DSL, wireless network, or other Internet connection at each retail location. Through this linked network, the rental experience for each consumer can be customized based on a profile for each consumer, such as via personalized home pages and rental screens.

The present invention allows for the predictive accrual of credits in a variable value transaction involving a piece of media content. The variable value transaction may include an initial balance that is satisfied at the initiation of the transaction, and a remaining balance that is not satisfied until the completion of the transaction. An availability of the credit may be determined for the piece of media content based on an applicability rule of the credit. The credit may be accrued for a predicted redemption for the remaining balance, if the credit is available. The credit may then be redeemed for the remaining balance when the variable value transaction is completed. A payment card may also be processed for a portion of the remaining balance. The piece of media content involved in the variable value transaction may be a physical media article vended from an article dispensing machine or a digital media selection at a content provider. The piece of media content may be rented, purchased, and/or reserved for later pickup. The value of the credit may vary depending on parameters of the variable value transaction, such as the type of the piece of media content, taxes, the type of the credits, and other parameters. Other features and advantages are provided by the following description and drawings.

### BRIEF DESCRIPTION OF THE DRAWINGS

FIG. 1 is an illustration of a system for communicating and processing information in a network of article dispensing machines and dispensing apparatus.

FIG. 2 is a perspective view of an article dispensing machine constructed in accordance with the principles of the present invention.

FIG. 3 is a high-level block diagram illustrating a networked media content system and connections including an article dispensing machine, a system backend, a content provider backend, an A/V display interface, and an external partner system.

FIG. 4 is a block diagram illustrating the system backend.

FIG. 5 is a block diagram illustrating connections from a credits system to the system backend, the article dispensing machine, the content provider backend, and the external partner system.

FIG. 6 is a diagram illustrating an exemplary data structure related to credits.

FIG. 7 is a table of exemplary credit definitions.

FIG. 8 is a table of exemplary credit packages.

FIG. 9 is a table of exemplary vendor SKUs.

FIG. 10 is a diagram illustrating possible states of a credit.

FIG. 11 is a flowchart illustrating operations for processing a variable value transaction with credits and a payment card.

FIG. 12 is a flowchart illustrating operations for predicting usage of credits for a variable value transaction.

FIG. 13 is a flowchart illustrating operations for redeeming credits for an initial balance of the variable value transaction.

FIG. 14 is a flowchart illustrating operations for redeeming credits for a remaining balance of the variable value transaction.

FIG. 15 is a flowchart illustrating operations for accruing credits in a variable value transaction.

FIG. 16 is a flowchart illustrating operations for another embodiment for accruing credits in a variable value transaction.

FIG. 17 is a flowchart illustrating operations for optimizing the redemption of credits in a variable value transaction.

FIG. 18 is a flowchart illustrating operations for managing a credit subscription.

FIG. 19 is a flowchart illustrating operations for creating a credit subscription.

FIG. 20 is a flowchart illustrating operations for converting currency items to credits.

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

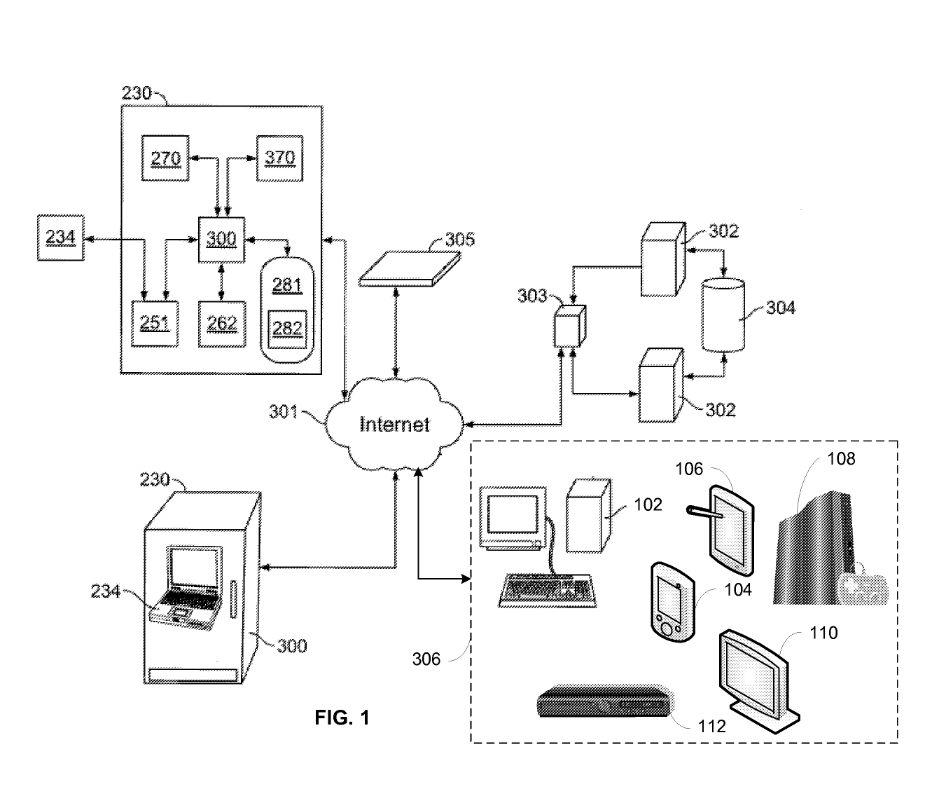

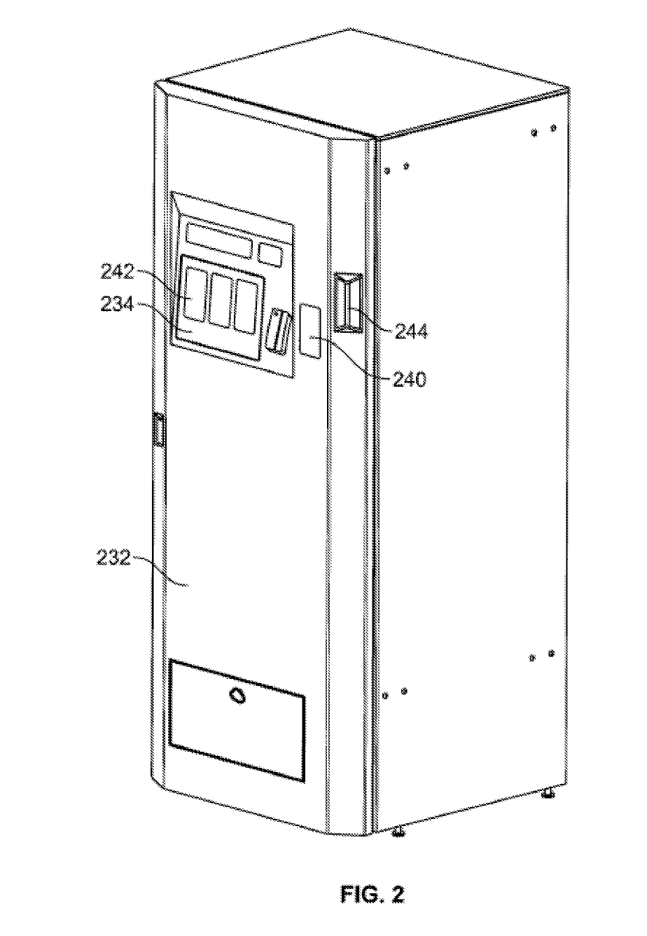

FIGS. 1-2 illustrate an article dispensing machine designated 230. Article dispensing machine 230 is one of a plurality of article dispensing machines included within an article distribution system having a plurality of such machines situated at a plurality of retail locations. The article dispensing machines of a particular article distribution system preferably form a network. As such, those machines are preferably in electrical communication with each other and with a central server or central controller.

As shown in FIG. 1, each article dispensing machine 230 includes a dispensing machine processor 300, also referred to herein as a vending controller, which is connected to a first sensor 270 and a second sensor 370, a first motor 251 and a second motor 262 and a user interface control system 234, collectively referred to as “the peripheral devices.” The processor is capable of executing various programs to provide input to and/or receive outputs from the peripheral devices. Suitable processors for such use are known to those of skill in the art. In addition, the processor is operably connected to at least one memory storage device 281, such as a hard-drive or flash-drive or other suitable memory storage device.

Article dispensing machine memory storage device 281 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, article dispensing machine memory storage device 281 may incorporate electronic, magnetic, optical, and/or other types of storage media. Article dispensing machine memory storage device 281 can have a distributed architecture where various components are situated remote from one another, but are still accessed by processor. Article dispensing machine memory storage device includes an article dispensing machine database 282.

The article dispensing machines 230 preferably comprise a network of machines in communication with one another. As shown in FIG. 1, in the preferred configuration, the article dispensing machines 230 are networked with one another via a central server or central controller 302 in a hub-and-spoke system. However, optionally, the article dispensing machines may be connected and communicate directly with one another, and/or subsets of article dispensing machines may communicate with one another directly as well as with the central server 302.

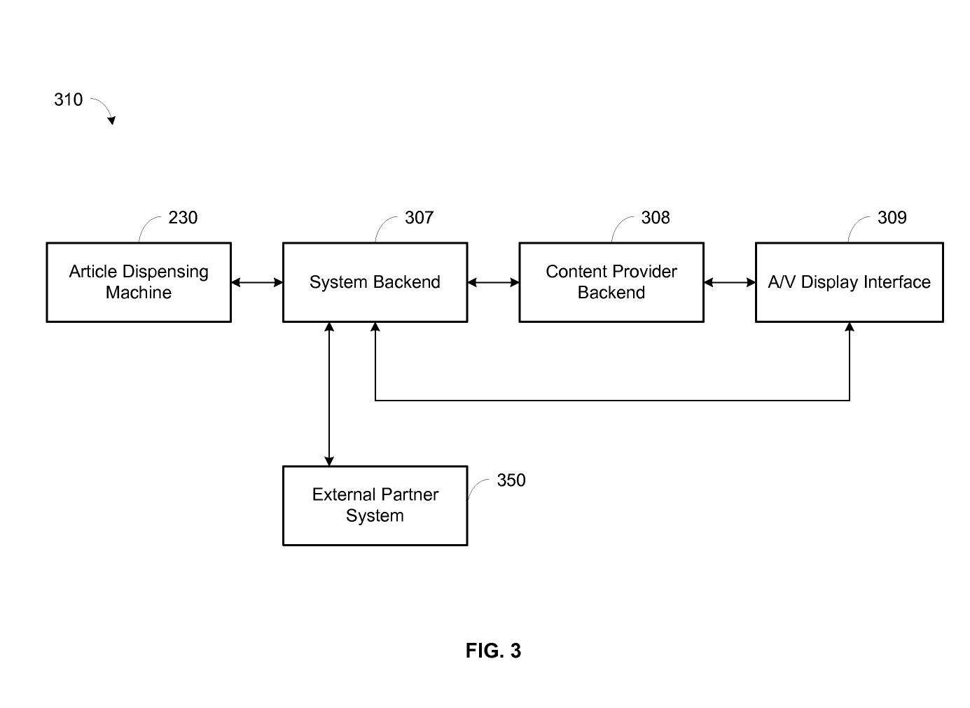

Generally, in terms of hardware architecture, the central server 302 and the content provider backend 308 shown in FIG. 3 include a central processor and/or controller, central memory, and one or more input and/or output (I/O) devices (or peripherals) that are communicatively coupled via a local interface. The architecture of the central server 302 is set forth in greater detail in U.S. Pat. No. 7,234,609, the contents of which are incorporated herein by reference. Numerous variations of the architecture of the central server 302 and the content provider backend 308 would be understood by one of skill in the art and are encompassed within the scope of the present invention.

The processor/controller is a hardware device for executing software, particularly software stored in memory. The processor can be any custom made or commercially available processor, a central processing unit (CPU), an auxiliary processor among several processors associated with the server 302, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. The processor may also represent a distributed processing architecture such as, but not limited to, SQL, Smalltalk, APL, KLisp, Snobol, Developer 200, MUMPS/Magic.

The software in memory may include one or more separate programs. The separate programs comprise ordered listings of executable instructions for implementing logical functions. The software in memory includes a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers, smartphones, or personal digital assistants (PDAs) (e.g., PalmOS available from Palm Computing, Inc., Windows CE or Windows Phone available from Microsoft Corporation, iOS available from Apple Inc, Android available from Google Inc., BlackBerry OS available from Research in Motion Limited, Symbian available from Nokia Corp.). The operating system essentially controls the execution of other computer programs and provides scheduling, input-output control, file and data management, memory management, and communication control and related services.

Steps and/or elements, and/or portions thereof of the present invention may be implemented using a source program, executable program (object code), script, or any other entity comprising a set of instructions to be performed. When a source program, the program needs to be translated via a compiler, assembler, interpreter, or the like, which may or may not be included within the memory, so as to operate properly in connection with the operating system (O/S). Furthermore, the software embodying the present invention can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, Ada, and Lua.

When article dispensing machine 230 is in operation, the article dispensing machine processor is configured to execute software stored within article dispensing machine memory, to communicate data to and from the dispensing machine memory, and to generally control operations of article dispensing machine pursuant to the software. The software aspects of the present invention and the O/S, in whole or in part, but typically the latter, are read by processor, perhaps buffered within the processor, and then executed.

When the present invention or aspects thereof are implemented in software, it should be noted that the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The present invention can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

For communication with the central server 302, article dispensing machine 230 is equipped with network communication equipment and circuitry. In a preferred embodiment, the network communication equipment includes a network card such as an Ethernet card. In a preferred network environment, each of the plurality of article dispensing machines 230 on the network is configured to use the TCP/IP protocol to communicate via the network 301. It will be understood, however, that a variety of network protocols could also be employed, such as IPX/SPX, Netware, PPP, and others. It will also be understood that while a preferred embodiment of the present invention is for article dispensing machine 230 to have a “broadband” connection to the network 301, the principles of the present invention are also practicable with a dialup connection using a standard modem. Wireless network connections are also contemplated, such as wireless Ethernet, satellite, infrared, radio frequency, Bluetooth, near field communication, and cellular networks.

The central controller 302 communicates with the article dispensing machine controllers 300 via the network 301. The central controller 302 is preferably located at a central station or office that is remote from the plurality of article dispensing machines 230. The central controller 302 can operate as the server for communicating over the network 301 between the plurality of article dispensing machines 230. The central controller 302 receives communications and information from the article dispensing machines 230, and also transmits communications and information to the machines 230. For example, when a rental transaction is performed at the article dispensing machine 230, transaction data such as the rented title is then transmitted from the machine 230 to the central controller 302 via the network 301. It will be understood that central servers in general, such as the central controller 302, are often distributed. A plurality of central servers/controllers 302 may optionally be arranged in “load balanced” architecture to improve the speed and efficiency of the network. To accomplish the implementation of multiple controllers 302, the controllers 302 may be in communication with a router/distributor 303.

The central controller 302 is also in communication with a central database 304. The central database 304 stores information regarding the transaction network. For example, the central database 304 stores data regarding the vending inventory at each of the plurality of article dispensing machines 230. The central database 304 also stores sales information regarding the sales quantities of the vending merchandise stored in the machines 230. For example, the central database 304 stores information regarding the sales totals for each title and for each machine 230 vending location. Central database 304 also stores user information and rental transaction information, such as user IDs, the date on which discs are due to be returned, the date on which discs were rented from the machines 230 and a list of valid coupon codes and restrictions associated with those codes. In certain embodiments, central database 304 also may be configured to store user PINs. Some of this information is also preferably stored in article dispensing machine database 282.

Central database 304 and databases in the content provider backend 308, such as a content provider customer profile database and other databases, are preferably relational databases, although other types of database architectures may be used without departing from the principles of the present invention. For example, the database 304 may be a SQL database, an Access database, or an Oracle database, and in any such embodiment have the functionality stored herein. Central database 304 is also preferably capable of being shared, as illustrated, between a plurality of central controllers 302 and its information is also preferably capable of being transmitted via network 301. It will be understood that a variety of methods exist for serving the information stored in central database 304. In one embodiment, .net and Microsoft Reporting Services are employed, however, other technologies such as ODBC, MySQL, CFML, and the like may be used.

The central controller 302, central database 304, and components of the content provider backend 308 are also accessible by an electronic device 306, which may include a personal computer 102, mobile device 104 (e.g., smartphone, personal digital assistant, etc.), tablet computer 106, video game console 108, television 110, and Blu-Ray player 112. The electronic device 306 may be in direct or indirect communication with the central controller 302, central database 304, and/or the content provider backend 308 through a wired and/or wireless network connection, such as Ethernet, Wi-Fi, cellular (3G, 4G, etc.), or other type of connection. As a personal computer 102, the electronic device 306 will be understood as comprising hardware and software consistent with marketable personal and laptop computers, such as a display monitor, a keyboard, and a microprocessor. The electronic device 306 may also comprise Internet browser software such as Firefox, Internet Explorer, Chrome, or Safari. Using the browser software, a user of the electronic device 306 can access a web interface through the central controller 302. An application may also execute on the electronic device 306 that accesses the central controller 302. To that end, central controller 302 preferably comprises web server software such as IIS or Apache. It will be understood that a variety of web server software and web browser software exists to implement the principles of the present invention without departing therefrom. Through the web browser software or application, the electronic device 306 communicates with the central controller 302 and allows the user to login to a central command functionality of the central controller 302 and to view and modify data stored in the central database 304. The browser interface or application also allows the user to perform certain system functions, which will affect the inventory and behavior of the article dispensing machines 230. The electronic device 306 may communicate with the central controller 302, central database 304, and components of the content provider backend 308 using rules and specifications of an application programming interface (API).

In a preferred embodiment, a financial server 305 is also in communication with the network 301. It will be understood that a variety of financial services exist for processing financial information via the Internet and other networks 301. Those services allow for the processing of credit card and debit card information, so that users of the services do not have to interface directly with credit and debit card companies. In FIG. 1, the financial server 305 is illustrated as a single server, although the financial server 305 may comprise an entire sub-network of financial servers 305 responsible for processing financial information.

As shown in FIG. 2, article dispensing machine 230 includes a machine housing 232 with front, rear, top, bottom, and side panels. The machine housing 232 is preferably a combination molded fiberglass and sheet metal cabinet. However, those skilled in the art will appreciate that the housing can be constructed from a variety of other suitable materials and with a variety of other suitable manufacturing techniques.

As shown most clearly in FIG. 2, a user interface portion 234 of housing 232 includes a card reader 240, a keypad and/or touch screen 242 and an article transfer opening 244. The card reader 240 is preferably designed in known fashion to read magnetically encoded membership and/or credit/debit cards for authorizing the distribution of articles of inventory through the article transfer opening 244. Keypad and/or touch screen 242 permits consumers and/or inventory stocking personnel to communicate with the dispensing machine 230 and/or a central office linked in electrical communication with the dispensing machine. Keypad and/or touch screen 242 also permits consumers and/or inventory stocking personnel to enter appropriate commands directed to carrying out specific machine tasks. It will be appreciated that the optional touch screen includes a monitor made with known technologies making it capable of being utilized as a user interface for entry of commands designed to carry out machine tasks. The touch screen 242 may also be capable of displaying a QR (Quick Response) code to a customer. The customer may read the QR code with a camera on a mobile device or with a dedicated QR code reader. The QR code can represent a universal resource locator (URL) to access a digital media selection or can represent a reference number for use by the customer when contacting customer service, for example.

Furthermore, it will be appreciated that additional user interface portions having additional or even identical user interface components could be incorporated within article dispensing machine 230. For example, these components could be incorporated on other panels of the housing 232 of machine 230 so that the machine can be used simultaneously by multiple consumers, translating into more efficient distribution of articles in high traffic areas. Dispensing machine 230 also preferably includes speaker units. Known audio technology may be incorporated within dispensing machine 230 to broadcast focused audio directed to relatively small (e.g., three square feet) locations in front of the machines from speaker units and/or in other designated locations at a retail site.

FIG. 3 illustrates a networked media content system 310 including an article dispensing machine 230, a system backend 307, a content provider backend 308, an audio/visual (A/V) display interface 309, and an external partner system 350. The networked media content system 310 provides for a variety of processes involving management, manipulation, searching, presentation, and notification related to digital media content and vendible physical media articles, including processes related to the present invention. The networked media content system 310 allows for direct and indirect communication between the components in the networked media content system 310 via one or more networks. The components in the networked media content system 310 may be operated by one or more entities. In one embodiment, the article dispensing machine(s) 230 and the system backend 307 are operated by a first entity, such as the operator of the article dispensing machines, while the content provider backend 308, the A/V display interface 309, and the external partner system 350 are operated by a second entity, such as a content provider. In another embodiment, all of the components shown in the networked media content system 310 of FIG. 3 are operated by the same entity. In a further embodiment, the article dispensing machine(s) 230 and the system backend 307 are operated by a first entity, the content provider 308 and the A/V display interface 309 are operated by a second entity, and the external partner system 350 is operated by a third entity.

The physical media article may include at least a DVD, Blu-Ray disc, video game disc, or other media article including those that are out-of-stock or otherwise unavailable for rental. The digital media selections may include streaming video content, video-on-demand content, downloadable video content, streaming video games, downloadable video games, or other digital media content. Streaming or downloadable video games may include content related to video games, such as expansion packs and add-on packs. Although FIG. 3 shows a single content provider backend 308, a single A/V display interface 309, and a single external partner system 350, it is contemplated that more than one content provider backend, A/V display interface, and/or external partner system may be in communication with the system backend 307.

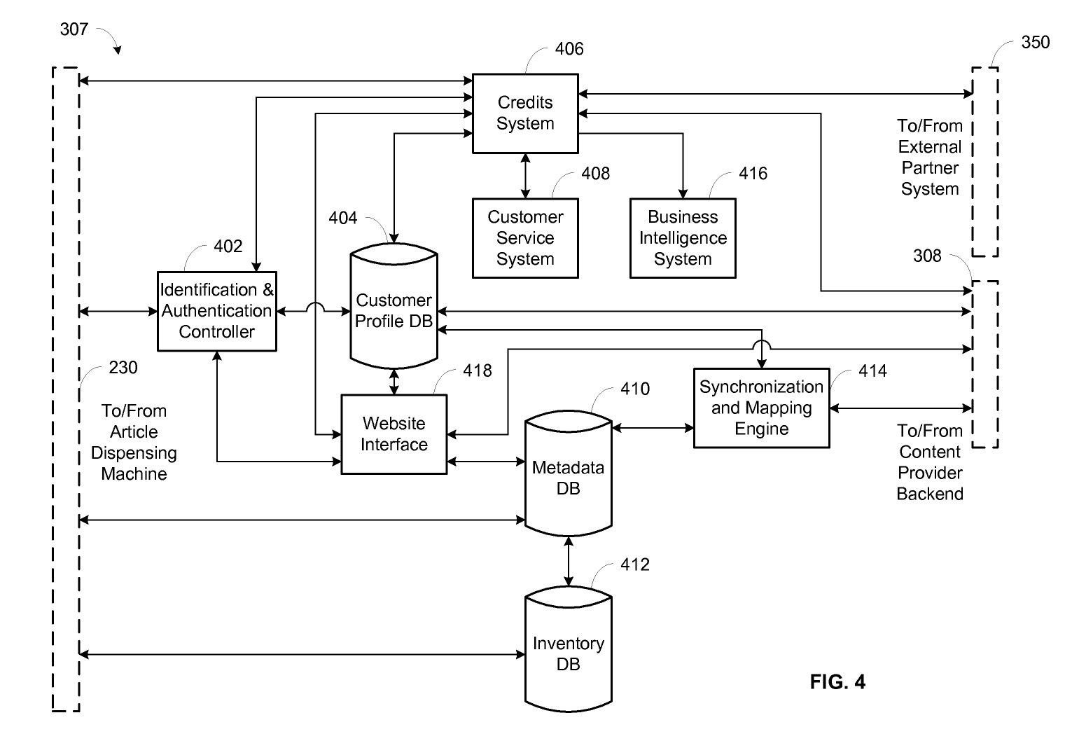

The system backend 307 includes components that primarily communicate information, such as transaction and inventory data, to and from the article dispensing machines 230. Components in the system backend 307 also communicate information to and from the content provider backend 308, the A/V display interface 309, and the external partner system 350. The system backend 307 is detailed below with reference to FIG. 4. The content provider backend 308 includes components that primarily communicate information to and from the A/V display interface 309. Components in the content provider backend 308 also communicate information to and from the system backend 307, as detailed further below. Data communicated between the article dispensing machines 230, the system backend 307, the content provider backend 308, the A/V display interface 309, and/or the external partner system 350 may utilize the XML (Extensible Markup Language) format, JSON (JavaScript Object Notation) format, or a proprietary format that may be agreed upon. The A/V display interface 309 and the external partner system 350 may communicate with the system backend 307 and/or the content provider backend 308 using rules and specifications of an application programming interface (API).

The A/V display interface 309 can be a set-top box, a module of an internet-ready television, a Blu-Ray player with internet connectability, a software application executing on a mobile device, cable television converter box, satellite television set-top box, IPTV (Internet Protocol television) set-top box (including AT&T U-Verse), digital video recorder, tablet computer, video game console (including Microsoft Xbox family, Sony PlayStation family, Nintendo Wii, and similar devices), handheld gaming device (including Sony PlayStation Portable, Nintendo DS, and similar devices), laptop computer, desktop computer, streaming media box (including Apple TV, Google TV, Roku, Boxee, and similar devices), or any other device capable of receiving and displaying streaming, on-demand, and/or downloadable electronic media from a content provider. Moreover, applications may be installed and executed on the A/V display interface 309 that communicate with the system backend 307 and/or the content provider backend 308 to provide media content and other information to a user of the A/V display interface 309.

The article dispensing machines 230 can communicate with the system backend 307, including the central server and controller 302, via network communication equipment and circuitry, as detailed above. Furthermore, the system backend 307 can communicate with the content provider backend 308 and the A/V display interface 309 via the same or different network communication equipment and circuitry. The external partner system 350 may also be in communication with components of the system backend 307 via the same or different network communication equipment and circuitry. In particular, the system backend 307 can directly communicate with the content provider backend 308, the A/V display interface 309, and/or the external partner system 350 or in one embodiment, the system backend 307 can communicate with the A/V display interface 309 through the content provider backend 308. It will also be understood that while a preferred embodiment of the present invention is for the components of the system 310 to have a “broadband” connection with one another, the principles of the present invention are also practicable with a dialup connection using a standard modem. Wireless network connections are also contemplated, such as wireless Ethernet, satellite, infrared, radio frequency, Bluetooth, near field communication, and cellular networks.

Each of the article dispensing machines 230 may operate without requiring continuous connectivity and communication with the central controller 302. In one embodiment, the central controller 302 only transmits data in response to communication from an article dispensing machine 230. For example, an article dispensing machine 230 may attempt to communicate with the central controller 302 following completion of one or more rental transactions or one or more media article return transactions. In another embodiment, the article dispensing machine 230 continues normal operations and transactions even if communication is interrupted or cannot be established with the central controller 302. Communication with the central controller 302 may be interrupted if the load at the central controller 302 is above a certain threshold. For example, the central controller 302 may direct the article dispensing machine 230 to only transmit certain types of messages and/or transactions, e.g., financial authorizations, until the load has decreased. In these cases, transaction data can be stored locally in the article dispensing machine 230, such as in the article dispensing machine memory storage device 281, until a predetermined time interval elapses, when a predetermined number of transactions is reached, until communication with the central controller 302 can be reestablished, or the load at the central controller 302 has decreased. Once communication is established with the central controller 302, financial and inventory information can be uploaded and the appropriate servers and databases can be updated.

In one embodiment, the article dispensing machine 230 can display only media articles which are physically located at the article dispensing machine 230. In this way, a customer may browse on the user interface 234 only the media articles which are in-stock and available to rent at that article dispensing machine 230. Typically, the article dispensing machine 230 possesses media information for the media articles that are currently located in the article dispensing machine 230. The media information for a media article includes title, actor, director, studio, publisher, plot synopsis, format, description, parental rating, individualized ratings and reviews, popularity, article type, running time, genre, cover artwork, or other information. The article dispensing machine 230 can also store in memory the media information for recently-rented media articles that are no longer physically stored in the article dispensing machine 230. The article dispensing machine 230 can communicate with the central controller 302 when media information about a particular media article is needed. For example, when a particular media article is returned to an article dispensing machine 230 that does not have the corresponding media information for that particular media article, the article dispensing machine 230 can query the central controller 302, metadata database 410, and/or inventory database 412 for the media information. Once the media information is obtained, the article dispensing machine 230 may display that particular media article on the user interface 234 as in-stock and available to rent.

In another embodiment, the article dispensing machine 230 can display media articles that are both physically located and not physically located at the article dispensing machine 230. In this embodiment, media articles which are both available and unavailable to rent can be displayed. A media article may be unavailable to rent if it is not in-stock or is in-stock but has been reserved for rental. In one example, the entire catalog of media articles stored in the inventory database 412 can be displayed on the article dispensing machine 230. In another example, a subset of the entire catalog of media articles can be displayed on the article dispensing machine 230. The subset of media articles that can be displayed on the article dispensing machine 230 may be determined, for example, based on geographic location, retailer agreements, contractual obligations, customer rental habits, and other criteria. The media articles that can be displayed on the article dispensing machine 230 may include recently-rented media articles that are no longer physically stored in the article dispensing machine 230 or media articles that have never been physically in the article dispensing machine 230. For example, media articles that have never been physically in the article dispensing machine 230 may be displayed because those media articles may be available at a nearby article dispensing machine. In this case, those media articles may be displayed to the customer so that the customer has an option to obtain those media articles from the nearby article dispensing machine 230. In this embodiment, if a customer attempts to rent a media article that is out-of-stock, reserved for another customer, or otherwise cannot be vended at the particular article dispensing machine 230, then that media article can be deemed an unavailable media article. Although a physical unavailable media article cannot be rented from the particular article dispensing machine 230, a digital alternative media selection may be available and substituted for the unavailable media article.

FIG. 4 is a block diagram illustrating the system backend 307 and connections to and from the system backend 307 to the article dispensing machines 230, the content provider backend 308, the A/V display interface 309, and the external partner system 350. The system backend 307 includes components that provide and receive data to and from the article dispensing machines 230 during DVD, Blu-Ray disc, and video game rental transactions and other transactions. Components in the system backend 307 are utilized in relation to the present invention, as described below. It will be understood that components 402, 404, 406, 408, 414, 416, and 418 in the system backend 307 may be implemented, for example, by the central controller 302 using instructions stored in a memory connected to the central controller 302. It will be further understood that the databases 404, 410, and 412 may be implemented as part of the central database 304 or as separate databases.

The identification and authentication controller 402 can receive a unique customer identifier that a customer provides to the article dispensing machines 230 during a transaction. The customer can also provide the unique customer identifier through an API 508 (described below) or on the website interface 418. The unique customer identifier can be a payment card (credit card or debit card) number, an opaque version of the payment card number similar to a hash or card alias provided by a payment gateway, or other unique identifier used for payment and/or identification purposes. The unique customer identifier may also be an identifier that is shared with an affiliate or external vendor and corresponds to an equivalent account at the affiliate or external vendor. In the case of hashing of a payment card number, the hash function applied to the payment card number may be implemented on the article dispensing machines 230 and may be, for example, a SHA-256 hashing algorithm. The identification and authentication controller 402 can validate the payment capability of a payment card by communicating with the financial server 305.

A customer may be authenticated to multiple customer profiles and accounts at the article dispensing machine 230 and/or at an affiliate or external vendor by the identification and authentication controller 402. In one embodiment, the unique customer identifier provided by the customer can authenticate the customer to an existing customer profile and account for the article dispensing machines 230. The existing customer profile and account can be stored and looked up using the unique customer identifier in the customer profile database 404 that is connected to the identification and authentication controller 402. The unique customer identifier can also link the existing customer account to a content provider customer account via a connection or reference from the customer profile database 404 to a content provider customer profile database in the content provider backend 308. Zero, one, or more content provider customer accounts may be linked in the customer profile database 404 to the existing customer account for the article dispensing machines 230. A content provider may include, but is not limited to, a cable television operator, a satellite television service provider, an IPTV (Internet Protocol television) provider, an online gaming and digital media delivery service (Xbox Live, PlayStation Network, OnLive, etc.), a website (YouTube, Hulu, etc.), a movie studio, a television network, a game publisher, a retailer (Best Buy, Walmart, etc.), or an offer/ticket seller (sports teams, musical groups, entertainment venues, etc.). Media selections available from a content provider may include videos on demand, streaming videos, downloadable videos, streaming video games, or downloadable video games. The media selections may be available through the A/V display interface 309 that is in communication with the content provider backend 308.

The customer profile database 404 can contain information related to customers of the article dispensing machines 230, including name, mailing and billing addresses, email addresses, phone and mobile numbers, username, password, payment methods, rental history, purchase history, preferred article dispensing machines, movie and video game genre preferences, customizations, subscriptions, parental controls, linked content provider accounts, content provider subscriptions and entitlements, and other data. A transaction can be personalized using information from the customer profile database 404 at the article dispensing machines 230 and a website interface 418. For example, only certain genres and titles of DVDs, Blu-Ray discs, or video games could be shown if a customer sets particular preferences that are then stored in the customer profile database 404. Some of the information stored in the customer profile database 404 may also be stored in the article dispensing machine database 282. Customer information stored in the customer profile database 404 may be looked up using a unique customer identifier, customer number, or other identifier. The customer profile database 404 may include a service which facilitates interfacing and communicating with components of the system backend 307, for example.

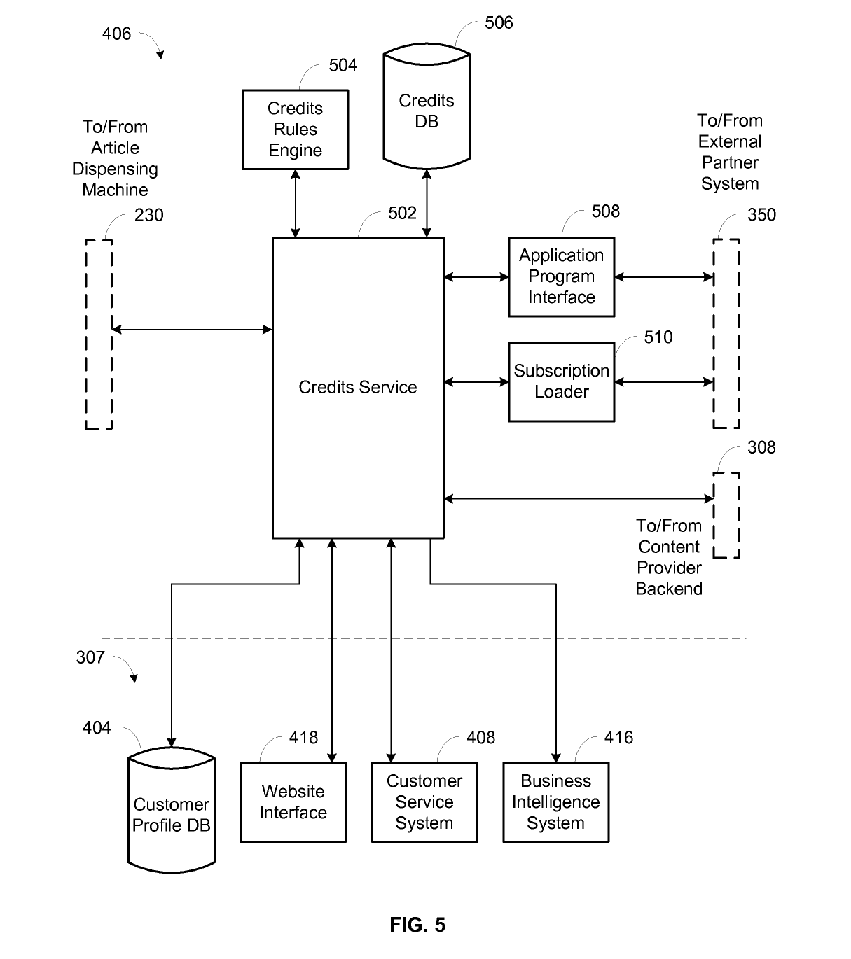

The website interface 418 can be interactive and accessible to a customer using web browser software at an electronic device 306. The website interface 418 may also include a mobile application or consumer electronics device application. Rentable media articles may be searched, browsed, and reserved on the website interface 418 for receipt at the article dispensing machines 230. The location of and the inventory at article dispensing machines 230 can be viewed at the website interface 418. Digital media selections from content providers, such as streaming, downloadable, and on-demand media, may also be searched, browsed, and accessed on the website interface 418. A customer can access their customer profile on the website interface 418 for purposes of verifying and updating their personal information in the customer profile database 404. For example, a customer can link an account they have with a content provider on the website interface 418 by specifying their username, password, account number, and/or other identifying information for the content provider account. The system backend 307 can utilize WS-Federation, SAML (Security Assertion Markup Language), OAuth (Open Authentication), or other protocols to assert and authenticate the identity of the customer at the content provider via a connection from the website interface 418 to the content provider identification and authentication controller 506 in the content provider backend 308, as shown in FIG. 5. If the identifying information matches the content provider account, the linkage to the content provider account can be stored in the customer profile database 404.

An inventory database 412 may contain a catalog of physical media articles that may be rented at the article dispensing machines 230 and reserved at the website interface 418 for later receipt at the article dispensing machines 230. The inventory database 412 may also include physical sell-through items, e.g., an empty case for replacement of a lost case, and digitally purchasable inventory items, e.g., event tickets, discounting offers, marketing offers, etc. A catalog of digital media selections available at the content provider can be contained in the metadata database 410. Metadata for the media articles and media selections are stored in the metadata database 410, including title, release date, running time, chapter information, technical details (resolution, audio options, languages, etc.), format, peripheral device requirements, number of players, online capability, actors, voice actors, director, studio, publisher, developer, platform, availability of downloadable content, episode information, genre, critic ratings, individualized ratings (reviews, recommendations, likes, etc.), parental ratings (MPAA, ESRB, TV Parental Guidelines, etc.), description, related content, media artwork, media stills, and other information.

Physical media articles that may be rented at the article dispensing machines 230 and digital media selections available at the content provider may be synchronized and mapped to one another by matching their respective metadata. A synchronization and mapping engine 414 connected to the customer profile database 404, the metadata database 410, and a content provider asset management system in the content provider backend 308 may compare the metadata for the media articles and media selections to determine matches. Metadata in the content provider asset management system for media selections can be compared to metadata in the metadata database 410 to perform the matching. For example, a combination of a title, release date, running time, and/or actor information can be used to map a media article to a corresponding media selection. In one embodiment, proprietary identification codes unique to a media article and a media selection can be used to map the media article to the corresponding media selection. The proprietary identification codes for the media article and the media selection can be stored in the metadata database 410 and the content provider asset management system, respectively. Such proprietary identification codes can be assigned to media articles and media selections by third party providers such as Rovi, Baseline, and AMG. In cases where media article/media selection matching algorithms fail or are not trustworthy, a media analyst oriented workflow system may be utilized to arrive at a correct and validated media mapping.

An inventory database 412 can be connected to the article dispensing machine 230 and the metadata database 410 to provide information regarding the availability of media articles in the article dispensing machines 230. The inventory database 412 and the metadata database 410 can provide inventory results for media articles and media selections to an application on an A/V display interface 309. Such results may include the availability of physical media articles at the article dispensing machines 230 as well as digital media selections available at a content provider. The results may also be provided to the website interface 418 or other websites operated by a content provider, for example. The synchronization and mapping engine 414 can store the information from the content provider asset management system regarding media selections at the content provider in the metadata database 410. The inventory database 412 can also supply the availability of media articles in the article dispensing machines 230 to the website interface 418 or to other portals, such as an application on a mobile device, when queried. The metadata database 410 may also include information regarding products that a credits system 406 may utilize in order to provide at least parts of applicability rules, as described below.

A credits system 406 can be connected to the article dispensing machine 230 and external partner system 350 to control, manage, and provide credits which may be redeemable for variable value transactions at the article dispensing machine 230, the website interface 418, and/or the external partner system 350. The credits system 406 may also be connected to the identification and authentication controller 402, the customer profile database 404, a customer service system 408, and a business intelligence system 416. Components may communicate with the credits system 406 using rules and specifications of an application programming interface (API). Credits can be redeemed for the rental, reservation, or purchase of one or more products, such as a piece of media content, e.g., a DVD, Blu-Ray disc, video game disc, digital media selection, or other product. Credits may be obtained through a one-time subscription, a periodic subscription, or be issued, such as through marketing promotions or from customer service. Credits may also be obtained by purchasing the credits in a manner similar to gift cards. Credits related to a periodic subscription may be deposited to a customer account on a periodic basis and may have an expiration date. For example, a customer may have a subscription for a particular number of credits that is deposited monthly and that expires monthly. The credits from a subscription may or may not rollover on a periodic basis. A customer may opt in or opt out of redeeming credits for products in a particular transaction. Customer loyalty and retention may be increased through the use of credits for variable value transactions because credits may be issued based on customer behavior, credits can be issued as incentives to customers, and credits may be used for products with different values.

Transactions involving the credits system 406 may include rentals, reservations, and/or purchases of physical media articles and digital media selections. For example, a customer may rent a media article from the article dispensing machine 230 by redeeming one or more credits for the transaction. As another example, a customer may redeem one or more credits to reserve a media article for later vending at the article dispensing machine 230. Such transactions may include two parts: an initial balance, such as the amount owed for an initial rental night, and a remaining balance, such as the amount owed for one or more extra rental nights. Both the initial balance and the remaining balance may be satisfied by redeeming credits and/or processing a payment card. The initial balance may vary, depending on factors such as taxes and the type of the piece of media content involved in the transaction. The remaining balance may also vary, depending on factors such as the type of the piece of media content involved in the transaction, taxes, and if and when the transaction is completed. The remaining balance may not be known until the transaction is closed, e.g., when a rented media article is returned, after a certain duration when the media article is assumed to be purchased, or when access to a media selection is relinquished.

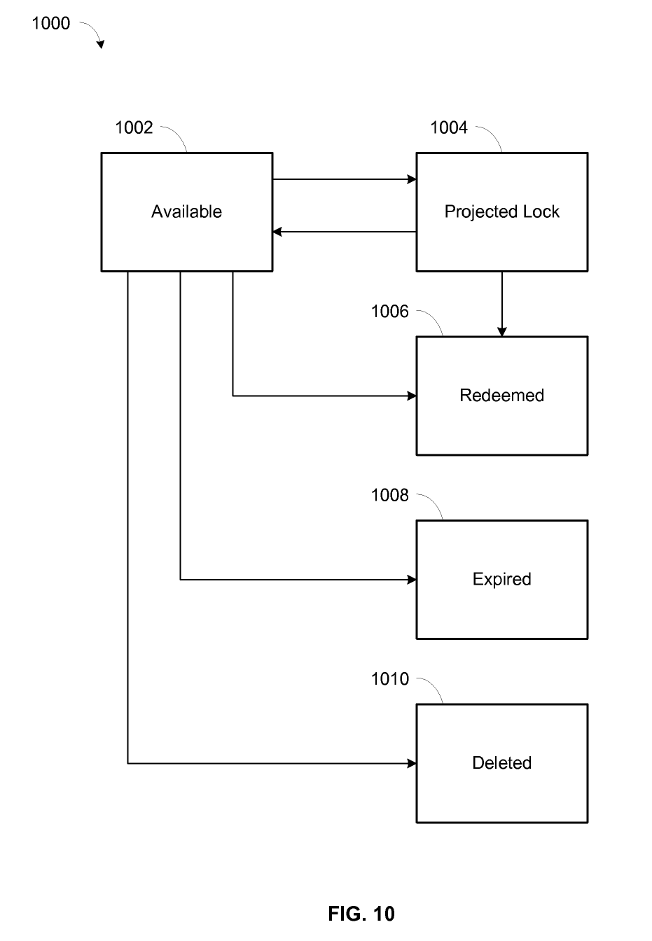

A state diagram 1000 of possible states of a credit in a variable value transaction is shown in FIG. 10. When initially created, a credit may be in an available state 1002 that specifies that the credit is available and can be redeemed as part of a variable value transaction. A credit in the available state 1002 may include a staging of the credit in an available state 1002 for future availability and redemption. Staging a credit in an available state 1002 may assist with calculations of credit accrual across recurrence boundaries, e.g., monthly. The credit may transition to a projected lock state 1004 from the available state 1002 when accruing and predicting the usage of credits for a remaining balance while a variable value transaction remains open. This may occur, for example, if a rented media article is kept for extra nights beyond the initial night. A credit would not be placed into the projected lock state 1004, however, when the credit system 406 is only predicting a future usage of credits prior to the initiation of a variable value transaction. Once in the projected lock state 1004, the credit may transition back to the available state 1002 if the projected lock of the credit erroneously occurred. This situation may happen, for example, if an article dispensing machine 230 that receives a return of a media article is not in communication with the credits system 406 at the time of the return, due to a network interruption or other interruption in communication. The credits system 406 may erroneously project a lock of a credit because it is believed that the media article had not been returned.

The credit may transition from the projected lock state 1004 to a redeemed state 1006 when a transaction is completed, e.g., the media article is returned, and the projected lock of the credit was performed correctly. A credit may also transition to the redeemed state 1006 from the available state 1002. This may occur to satisfy for an initial balance of the variable value transaction, such as upon a rental, purchase, or reservation of a piece of media content. A credit may also be in an expired state 1008 or a deleted state 1010. In an expired state 1008, a credit has been determined to be no longer valid because it has reached its expiration date. A credit may be in the deleted state 1010 when the credit was incorrectly created and needs to be deleted.

Referring back to FIG. 4, a customer service representative may use the functionality of the customer service system 408 to manage credits for customers. The customer service system 408 may allow for retrieving a customer's available credits, credit subscriptions, the origination of credits (e.g., what business event originated the credit), credit usage history, and other credit-related information. Credits may also be created and deleted in the customer service system 408. For example, if a customer rents a media article that is unplayable, a credit may be deposited or refunded to the customer's account through the customer service system 408. In the case where a customer does not have an existing account, an account may be created to deposit the credits. As another example, a customer service representative may use the customer service system 408 to view credits for a customer that are in the available state 1002 and projected lock state 1004. Credits that are in a projected lock state 1004 can include credits that may be redeemed in the future for a remaining balance of an open transaction, e.g., when a media article has not yet been returned. The business intelligence system 416 can include a database and functions for analyzing and mining data and trends related to customer transactions, including transactions involving the use of credits. Credit-related information can be exported to the business intelligence system 416 on a periodic basis or as part of the orchestration of a business event within an ESB (enterprise service bus), such as through an extract, transform, and load (ETL) process. In the context of credits, the business intelligence system 416 can analyze transactions, for example, to determine the usage and value of credits for a particular customer.

FIG. 5 is a block diagram illustrating the credits system 406 and connections to and from the credits system 406 to the article dispensing machines 230, the external partner system 350, the content provider backend 308, and components in the system backend 307. The credits system 406 includes components that control, manage, and provide credits related to transactions involving the article dispensing machines 230, website interface 418, and/or the external partner system 350. Components in the credits system 406 are utilized in relation to the present invention. It will be understood that components 502, 504, 508, and 510 in the credits system 406 may be implemented, for example, by the central controller 302 using instructions stored in a memory connected to the central controller 302. It will be further understood that the credits database 506 may be implemented as part of the central database 304, as a separate database, or be split across any number of databases.

A credits service 502 can be accessed during variable value transactions through the article dispensing machine 230, website interface 418, or API 508 for redeeming credits, predicting an estimated usage of credits, and tracking the predicted accrual of credits. The credits service 502 can also be accessed by the customer service system 408, as described above, for customer service-related management of credits for customers. When credits are redeemed, the credits service 502 can optimize how credits are redeemed in balancing revenue recognition and value to the customer. Furthermore, the external partner system 350 can interface with the credits service 502 through the API 508 to manage credits subscriptions for customers. The credits service 502 may be implemented as a Windows Communication Foundation 4 SOAP-based service, a REST (Representational State Transfer)-based service, a queue endpoint, or other type of service. A credits database 506 may contain information related to credits for customers. Credits may be looked up in the credits database 506 by a customer number associated with a particular customer profile, for example.

Credits may be redeemed by the credits service 502 for the rental, reservation, or purchase of products in a transaction, including for pieces of media content like media articles such as DVDs, Blu-Ray discs, and video game discs, and digital media selections. In particular, the credits service may redeem credits for some or all of the initial balance and/or the remaining balance of a variable value transaction. The credits service 502 can also predict the usage of credits for a particular transaction prior to redemption of the credits. Predicting the usage of credits may be useful in cases when a customer wants to use credits for a transaction but does not know their credit balance, or when a customer has an open transaction with an unknown remaining balance.

Tracking the predicted accrual of credits is performed by the credits service 502 to monitor the usage of credits that might be redeemed when an open transaction is closed. For example, a transaction can be open when a product has been rented but not yet returned. While the initial balance has been satisfied (by a credit or a payment card), the remaining balance is not satisfied until the transaction is closed. The credits service 502 may also include a credit job that is a process that is scheduled to be executed on a periodic basis. The credit job may be responsible for executing tasks related to the creation of credits by customer subscription, expiring credits, removing records for closed transactions within the credits database 506, accruing credits, publishing credits-related data to the business intelligence system 416, and other tasks. The credit job may be a Windows service or SQL Server Integration Services (SSIS) ETL package, for example.

Payment cards may be issued that are based on credits, which could be used to satisfy balances related to variable value transactions or for other transactions. External affiliates, vendors, and partners may buy credits so that they can re-sell the credits or offer the credits to customers as part of marketing initiatives. Credits may also be provided as part of a loyalty program, such as granting of credits for marketing purposes as incentives or rewards for certain customer behavior. Financial reporting of revenue, pending revenue, taxes, and other metrics may be affected by the sale, redemption, and/or granting of credits.

A credits business rules management system 504 may be accessed when the credits service 502 is called to redeem, predict usage of, and track the predicted accrual of credits involved in a variable value transaction. Credits may have a variable value depending on factors such as the product to which the credits are applied, taxes, the source of the credits, and other factors. Applicability rules within the credits business rules management system 504 may determine which credits are applied to and redeemed for particular products in a transaction. The applicability rules may be based on attributes of the credits, such as the type of product the credit may be applied to, the expiration date of the credit, an exclusivity of the credit, the channel where the credit is being redeemed (e.g., at an article dispensing machine 230, at the website interface 418, etc.), and other attributes. The credits business rules management system 504 may also apply promotion codes or take into account the impact of promotion codes to one or more individual items in a transaction or to an entire transaction. Promotion codes can be redeemed to discount a transaction for a particular amount, and are not tracked by the credits service 502. The credits business rules management system 504 may be implemented using a rules engine from a provider of business rule management system (BRMS) technology, such as Fair Isaac Corporation, for example, and may be abstracted from the credits service 502 using a provider model pattern. Because credits may have a variable value, it is possible to test variations in the prices charged for transactions involving pieces of media content, as part of future business planning initiatives.

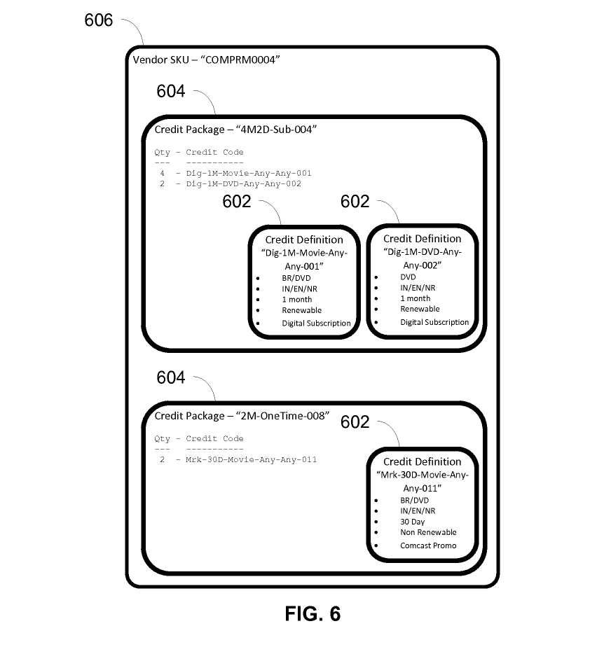

Credits in the credits database 506 may be stored in an appropriate data structure that may differ dependent on the state of the credit. In one embodiment, detailed in FIG. 6, a credit may be defined in a credit definition 602. One or more credit definitions 602 can be referred to in one or more credit packages 604, and one or more credit packages 604 may be referred to under one or more vendor SKUs (stock-keeping units) 606. Accordingly, a vendor SKU can translate into multiple credit definitions. The relationship between the vendor SKU 606, credit packages 604, and credit definitions 602 is detailed further below.

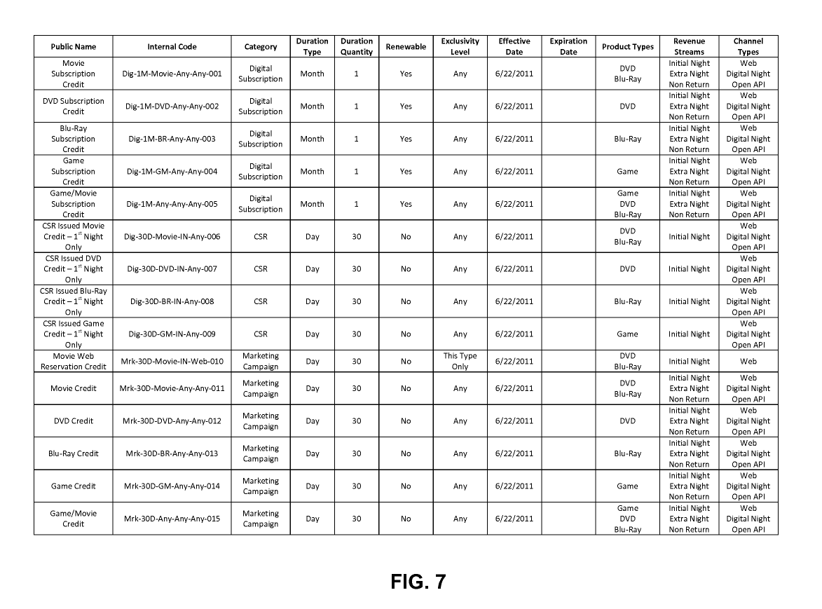

A credit definition 602 can include attributes that allow the applicability rules in the credits business rules management system 504 to determine whether a particular credit may be redeemed in a transaction. An exemplary list of credit definitions is shown in the table of FIG. 7. The attributes of a credit definition 602 may include a public name that describes the credit, an internal code for identifying the credit, a category for classification, duration information, whether a credit is renewable, how a credit may be used with other credits (exclusivity level), dates defining when the credit may be issued, applicable product types, applicable revenue streams, and applicable channels. A revenue stream may include an initial night (corresponding to an initial balance), an extra night (corresponding to a remaining balance), and a non-return (corresponding to when a product is assumed to be purchased after a predetermined duration). A channel may include an article dispensing machine 230 (“digital night”), the website interface 418 (“web”), and/or the external partner system 350 (“open API”). The website interface 418 may also include a mobile application or consumer electronics device application. Any number of applicability rules may be defined within the credits business rules management system 504 that can leverage incoming information (e.g., a shopping cart), customer information, product information, article dispensing machine 230 information, and other internal and external sources. One example of an external source is a source for weather patterns so that a “rainy day Monday” credit will only work on Mondays that it rains.

For example, in the table shown in FIG. 7, the credit definition with the public name “Movie Subscription Credit” has an internal code of “Dig-1M-Movie-Any-Any-001”. This credit is categorized under Digital Subscription, has duration information of monthly, and is renewable because it may be part of a renewable monthly subscription. The credit can be used with other credits and can be issued as of Jun. 22, 2011. The absence of an expiration date denotes that there is no end date for when the credit may no longer be issued. This credit is applicable to DVDs and Blu-Ray discs, can be used for initial nights, extra nights, and non-returns, and can be redeemed on the website interface 408, article dispensing machine 230 (digital night), or through the external partner system 350 (open API). As another example, the credit definition with the public name “CSR Issued Game Credit—1st Night Only” in FIG. 7 has an internal code of “Dig-30D-GM-IN-Any-009”. This credit is categorized as CSR (Customer Service Representative) because it may be issued by customer service if a customer has an issue with a transaction or product. The credit has a 30 day duration before it expires and it is not renewable. The credit may be used with other credits and can be issued as of Jun. 22, 2011. This credit is only applicable for game discs for an initial night rental. The credit can be redeemed on the website interface 408, article dispensing machine 230, or through the external partner system 350.

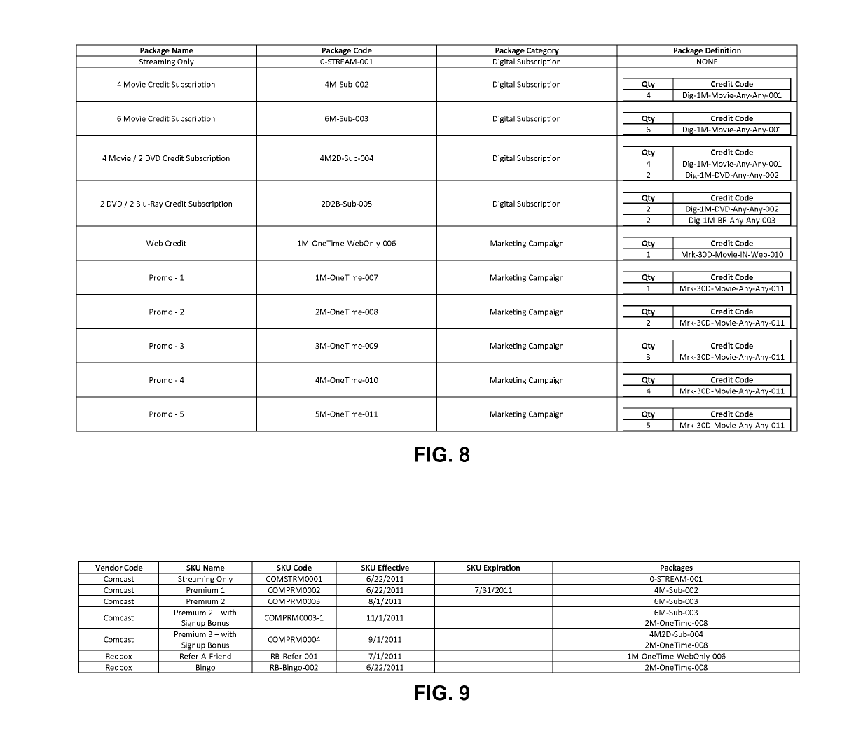

Each credit definition 602 can be referred to in one or more credit packages 604. An exemplary list of credit packages 604 is shown in the table of FIG. 8. A credit package 604 can be a collection of various credits and the corresponding quantity of each credit. The attributes of a credit package 604 may include a name describing the credit package 604, a package code for identification, a general source for the credits, a category for classification, and the collection of credit definitions 602 in the credit package 604, including a quantity for each credit definition 602. For example, in the table shown in FIG. 8, the credit package with the name “4 Movie/2 DVD Credit Subscription”, has an internal code of “4M2D-Sub-004”, and is categorized under Digital Subscription. This credit package contains four of the credits referred to as “Dig-1M-Movie-Any-Any-001” and two of the credits referred to as “Dig-1M-DVD-Any-Any-002”. These credits can be seen in the table of FIG. 7.

Each credit package 604 may in turn be referred to under one or more vendor SKUs (stock-keeping units) 606. An exemplary list of vendor SKUs 606 is shown in the table of FIG. 9. A vendor SKU 606 may be referred to by the external partner system 350 or by the customer service system 408 to refer to a particular set of credits and/or credit packages. For example, an external partner using the external partner system 350 may want to initiate or manage a subscription for a customer. The vendor SKU 606 can have attributes including a vendor code, a SKU name, a SKU code for identification, dates defining when the SKU may be used, references to external affiliate systems or external vendor systems, and which credit packages 604 are associated with the SKU. For example, in the table shown in FIG. 9, a vendor SKU 606 may have a vendor code of “Comcast”, a SKU name of “Premium 1”, and a SKU code of COMPRM0002. The external partner may designate and refer to the SKU using the SKU code. This vendor SKU can be used between Jun. 22, 2011 and Jul. 31, 2011, and includes the credit package 4M-Sub-002. The credit package 4M-Sub-002 includes four instances of the Dig-1M-Movie-Any-Any-001 credit definition. This credit package can be seen in the table of FIG. 8.

Returning to FIG. 5, an application program interface (API) 508 may be connected to the credits service 502 to allow for an external partner system 350 to leverage credits through their system 350. The API 508 may be accessed using an application executing on an electronic device 306, A/V display interface 309, or a website of the external partner system 350, for example. The functionality associated with the credits service 502 may be accessed through the API 508 so that an external partner system 350 can utilize credits in the same way as the article dispensing machine 230 and website interface 418. An identification of the external partner system 350 may be required to use the API 508.

A subscription loader 510 can act as an intermediary between the external partner system 350 and the credits service 502 to allow for management of credit subscriptions. The external partner system 350 can transmit messages to the subscription loader 510 that contains information about credits that should be created, renewed, modified, and/or deleted for particular customers. The messages can be in an XML file or other appropriate format. Attributes in the messages may include a customer shared key for identifying the customer, a vendor SKU code for identifying a particular set of credit packages and/or credits, and/or a subscription lifetime. Messages may also direct the upgrade, downgrade, cancellation, and/or extension of credit subscriptions, and may account for other parameters related to credit subscriptions, such as a grace period. In one embodiment, the subscription lifetime may be specified in the attributes if the subscription loader 510 is to perform refreshing of the credits on a periodic basis. In another embodiment, the external partner system 350 may periodically transmit a message with the appropriate attributes in order to manually perform refreshing of the credits on a periodic basis. The subscription loader 510 may include a queue to efficiently manage incoming messages.

The customer shared key in a message can be an identifier for a particular customer that is known to both the external partner system 350 and the customer profile database 404. A customer may have more than one customer shared key, each of which is known to a different external partner but identifies the same customer. Accordingly, when a message is received, the credits service 502 can translate the received customer shared key to a customer number or other unique identifier. The credits service can subsequently manage the credits in the credits database 506 for the particular customer according to the received message. The connection between the subscription loader 510 and the external partner system 350 can be through a virtual private network (VPN), other secured network, secured filed transfer, or secured web services.

The credits service 502 may include functions that can be called by the article dispensing machine 230, the external partner system 350 (through the API 508 and the subscription loader 510), the website interface 418, and the customer service system 408. The functions can be categorized into runtime, management, subscription, batch subscription, and maintenance namespaces. Functions may be called by transmitting request messages with parameters, and functions may respond to a request message with a response message. An incoming request message may include an optional IncludeStatusInResponse flag that indicates to the credits service 502 whether a response message should include informational messages. A request message may also include information regarding the channel (e.g., article dispensing machine 230, website interface 418, etc.) calling the function. Accordingly, a response message may include one or more informational messages, if the IncludeStatusInResponse flag was set in the incoming request message. Informational messages may include descriptions of why the request message did not pass a validation check, such as “CustomerNumber cannot be missing or null” and “Price cannot be less than zero”. In one embodiment, a response message may not return a status code reflecting the outcome of the function. In another embodiment, a response message may include status codes.

Furthermore, the credits service 502 may validate incoming request messages to check that the parameters of the request message conform to specifications. If a request message does not validate, then the credits service 502 may return a ValidationFault error to the calling entity. In addition, if the credits service 502 encounters any unexpected exceptions or states in the processing of a request message for a function, the credits service 502 may return a GeneralFault error to the calling entity.

The runtime namespace may be used during variable value transactions through the article dispensing machine 230, the API 508, and the website interface 418. Such variable value transactions may involve a credit cart structure that contains a list of items involved in the transaction, as well as any higher level information related to the transaction, such as a promotion code. The credit cart may be used in the credits service 502 to keep track of items in an open transaction, as described above. The credit cart may initially contain the same items in a “shopping cart” used by a customer at the article dispensing machine 230, through the API 508, or on the website interface 418. The items in the credit cart may be considered open items while the variable value transaction remains open. The open items in the credit cart may subsequently be closed as the items are returned. The items in the credit cart may include media articles and/or media selections involved in a rental, reservation, and/or purchase transaction. In this way, the status of items involved in a variable value transaction can be tracked using the credit cart.

Functions in the runtime namespace include PredictCredits for estimating the usage of credits in a transaction, RedeemCredits for redeeming credits for a transaction, CloseCartItems for removing items from a cart in an open transaction, and GetCredits for obtaining a list of active credits for a customer. The PredictCredits function can inspect a cart passed into the function and attempt to estimate the assignment of credits to items in the cart, depending on the availability of credits for a customer and the applicability of the credits to the items. The PredictCredits function may access the credits business rules management system 504 and the credits database 506 to perform the credit estimation, and may be called prior to vending of an item from an article dispensing machine 230 and/or prior to reservation of an item for later vending. The PredictCredits function may also be called prior to obtaining access to a media selection. Parameters passed into the PredictCredits function may include a customer number for identifying the customer involved in a transaction, and cart information, such as a list of items in the cart and a cart discount amount related to a promotion code. The list of items can include a product number identifying the item, a type of product (e.g., DVD, Blu-Ray disc, video game disc), the applicable revenue stream (e.g., initial night, extra night, passive sale/non-return), the original price of the item, date information, and an item discount amount.

The PredictCredits function only estimates a usage of credits for a transaction and does not place any credits into a projected lock state 1004 or a redeemed state 1006. The current credits available for redemption by the customer are taken into consideration when the PredictCredits function is called. Credits that were available in the past or will be available in the future are not taken into consideration. Outputs returned by the PredictCredits function can include the number of credits remaining for the customer and the predicted allocation of credits, if any, for zero, one, or more of the items in the cart. The predicted allocation may include the product number, the number of credits, and the credit amount for each of the items in the cart. A total monetary amount of the value of the predicted allocation of credits may also be returned.

The RedeemCredits function can redeem credits for items in a transaction, depending on the availability of credits for a customer and the applicability of the credits to the items. The RedeemCredits function may be called to satisfy an initial balance after the vending of an item from an article dispensing machine 230, after the reservation of an item for later vending, or after obtaining access to a media selection. This function may also be called to satisfy a remaining balance after a return of the item including extra nights, after a non-return resulting in a passive sale of the item, or after relinquishing access to a media selection. The credits business rules management system 504 and the credits database 506 may be accessed by the RedeemCredits function to perform the credit redemption. The RedeemCredits function and the PredictCredits function may operate independently—in other words, any previous calls of the PredictCredits function have no impact on a call to the RedeemCredits function. Parameters passed into the RedeemCredits function may include a customer number, a transaction number, and cart information, such as a list of items in the cart and a cart discount amount related to a promotion code. The list of items can include a product number identifying the item, a type of product, the applicable revenue stream, the original price of the item, date information, and an item discount amount.

The RedeemCredits function can transition credits from an available state 1002 or a projected lock state 1004 to the redeemed state 1006. Outputs returned by the RedeemCredits function can include the number of credits remaining for the customer and the allocation of credits for zero, one, or more of the items in the cart. The allocation may include the number of credits and credit amount for each of the items in the cart, as well as the product type, product number, revenue stream, and date information for the redeemed credits. A total monetary amount of the value of the allocation of credits may also be returned. The PredictCredits function and/or the RedeemCredits function may be configured to provide no transactional locking, optimistic transactional locking, or pessimistic transactional locking

Applicability rules may be processed by the credits business rules management system 504 when the PredictCredits or RedeemCredits functions are called. The applicability rules may be based on attributes in the individual credit definitions, for example, to determine whether a credit can be applied to a particular item in a transaction. Applicability rules may define when and how a credit can be used. An example of an applicability rule may include particular products that a credit is eligible to be redeemed for, e.g., DVDs only, or DVD and Blu-Ray discs. Another example of an applicability rule may include defining that a credit may only be good on a certain day, e.g., St. Patrick's Day. A further example of an applicability rule may include specifying an order for which products may be discounted or allow credit redemption. Another example of an applicability rules may include the rule being used as a generalized discounting scheme, such as discounting certain products by a set amount. A further example of an applicability rule may include unique promotional and marketing events, such as allowing credits to be used on “old Harrison Ford movies on rainy Thursdays”.

The CloseCartItems function may be called when an item is returned, after non-pickup of a reserved media article, after relinquishing access to a media selection, or when there is no remaining balance in the variable value transaction. The CloseCartItems function may also be called if the credits service 502 detects the occurrence of these events (return of an item, non-pickup of a reserved media article, relinquishment of access to a media selection, or no remaining balance in the transaction) regardless of whether the events were registered with the credits service 502. This may occur, for example, when the item is returned on time and there are no extra nights that need to be charged for. An article dispensing machine 230 may call the CloseCartItems function when a media article is returned, for example. Any accrued credits that are in a projected lock state 1004 for the products in the cart being closed may be released by the CloseCartIems function. Parameters to be passed into the CloseCartItems function may include a transaction number and the product number of the item being returned.

The active credits returned by the GetCredits function includes credits that are in an available state 1002 or projected lock state 1004, but not credits that are in a redeemed state 1006, expired state 1008, or deleted state 1010. Parameters that may be passed into the GetCredits function include a customer number for the customer whose credits are being retrieved. The information returned about the active credits may include a credit identification number, the state of the credit, a modified date, an effective date, an expiration date, the corresponding credit definition, and information related to an allocation of the credit for a particular item (if the credit is in a projected lock state 1004). The GetCredits function may also be called by the customer service system 408.

The management namespace includes the CreateCredits, DeleteCredits, GetCreditUsage, GetCreditDefinitions, and UpdateAccrual functions. The CreateCredits and DeleteCredits functions may be called by the customer service system 408. In particular, the CreateCredits function can create for a customer a specific number of credits corresponding to a specified credit definition. The created credits will be stored in the credits database 506 for the customer. The date the CreateCredits function is called will be the effective date of the created credits. Parameters passed into the CreateCredits function may include the customer number, credit definition code, and the quantity of credits to create. The DeleteCredits function can delete a particular credit for a customer. The deleted credits will be transitioned to a deleted state 1010 as a result of the DeleteCredits function. Parameters passed into the DeleteCredits function may include the credit identification number of the credits to be deleted.

The GetCreditUsage and GetCreditDefinitions functions may be called by the customer service system 408, the website interface 418, and the API 508. The GetCreditUsage function may return the credit usage history for a customer for a particular date range, or the credit usage for a particular transaction. Parameters passed into the GetCreditUsage function may include a customer number and date range information, or a transaction number. Credits returned by the GetCreditUsage function include credits that are in a redeemed state 1006, expired state 1008, or deleted state 1010. The information returned about the credit usage history may include a credit identification number, the state of the credit, a modified date, an effective date, an expiration date, the corresponding credit definition, and information related to an allocation of the credit for a particular item (if the credit is in a redeemed state 1006).

The GetCreditDefinitions function may return a list of credit definitions and their basic attributes. In one embodiment, the attributes for all of the credit definitions may be returned, such as if no parameters are passed into the call to the function. The credit definitions can be requested by category or particular credit definition code, or all credit definitions can be returned by the GetCreditDefinitions function. For example, a customer service representative may want to create a credit for a customer, but would like to look up the credit definition in order to get the correct credit definition code.

The UpdateAccruals function may be called to accrue credits in the case where a transaction remains open. The cart corresponding to the open transaction may be updated by the UpdateAccruals function and credits that may be used to satisfy the remaining balance of an open transaction may be transitioned to a projected lock state 1004, if appropriate. Parameters passed into the UpdateAccruals function may include a customer number and a date range for which to update the accrual of credits.

The subscription namespace includes the CreateSubscription, UpdateSubscriptionExpiration, UpgradeDowngradeSubscription, CancelSubscription, GetSubscriptions, and GetSkus functions. These functions may be called by the customer service system 408, the web interface 418, and the API 508. The CreateSubscription function can create one or more new credit subscriptions for a customer. Credit subscriptions that are created can be one-time or recurring subscriptions. As described above, the external partner system 350 can use the subscription loader 510 to manage subscriptions for customers. Parameters to be passed into the CreateSubscription function include a customer number, a vendor-specific customer number, a vendor code, a SKU code, a start date, and an end date. The calling entity may also specify whether the created subscription is unique. In one embodiment, the vendor-specific customer number may be optional and the customer number may be a customer shared key, as described above. The CreateSubscription function may be called in response to a message received at the subscription loader 510 from the external partner system 350, for example. After processing the CreateSubscription function call, the credits service 502 may internally call the CreateCredits function to manage the credits that were modified by the CreateSubscription call. The internal call of the CreateCredits function may be done asynchronously and/or as a part of a daily executed job. In the case when a subscription does not have an end date, the corresponding credits may be created for the customer for a predetermined amount of time in the future. This may occur when the subscription loader 510 is responsible for generating credits on a periodic basis, in contrast to when the external partner system 350 periodically transmits messages to the subscription loader 510 to renew a subscription. A unique subscription handle identifier for the newly created subscription may be returned by the CreateSubscription function.

The UpdateSubscriptionExpiration function can update the expiration date of an existing credit subscription. Parameters to be passed into the UpdateSubscriptionExpiration function include a unique subscription handle identifier, the new expiration date, and/or whether the subscription does or does not expire after the new expiration date. The UpgradeDowngradeSubscription function can change the characteristics of an existing credit subscription. For example, an existing subscription can be changed to reflect the credits included in a different vendor SKU, credit packages, and/or credit definitions. When the UpgradeDowngradeSubscription is called, the existing customer number and vendor code may be carried over from the existing subscription. Parameters that may be passed into the UpgradeDowngradeSubscription include a unique subscription handle identifier and the changes to the subscription, such as a new vendor SKU, date information, subscription expiration information, and subscription uniqueness information. The UpgradeDowngradeSubscription may return a new unique subscription handle identifier that identifies the modified credit subscription.

The CancelSubscription function can cancel an existing credit subscription by setting the expiration date of the subscription to the current date. Any credits for a customer that were pre-issued but not effective until a future date would be deleted as a result of the CancelSubscription function. However, credits for a customer that have already been issued and are currently effective would remain in the available state 1002 for use until the credits have expired. The unique subscription handle identifier identifying the credit subscription to be cancelled may be passed into the CancelSubscription function. The GetSubscriptions function may return a list of subscriptions for a particular customer. The list of subscriptions may be requested by customer number, vendor code, SKU, or subscription handle. Parameters passed into the GetSubscriptions function may include a customer number, a vendor code, a vendor SKU, and/or unique subscription handle identifier. The subscriptions returned by the GetSubscriptions function may include a subscription identification number, a SKU name, an effective date, and an expiration date. The GetSkus function may be called to obtain a list of all vendor SKUs. As described above, a vendor SKU can correspond to one or more credit packages, which in turn correspond to one or more credit definitions. The vendor code for a particular vendor may be passed in as a parameter to the GetSkus function. If no parameter is specified, all SKUs for all vendors may be returned. The SKUs returned by the GetSkus function may include a SKU code, a SKU name, an effective date, an expiration date, a vendor code, and a vendor name. The GetSkus function may be called, for example, so that the external partner can obtain a list of the SKUs that can be assigned to a customer subscription.

The batch subscription namespace includes the CreateBatch, UpdateBatchStatus, ProcessBatch, LoadSubscriptionRequest, UpdateSubscriptionRequest, and ProcessSubscriptionRequest functions. Many transactions related to the management of credit subscriptions may be performed and/or request simultaneously through the use of functions in the batch subscription namespace. For example, multiple credit subscriptions for one or more customers may be created through use of the batch subscription functions, such as when a large number of users are migrated from a legacy system into the credits system 406. In one embodiment, the subscription loader 510 may receive messages from the external partner system 350 that direct the management and processing of batch credit subscriptions.

The maintenance namespace includes scheduled periodic processes related to the credit job described above, such as ManageCredits, CleanOpenCarts, and PublishJobs. The ManageCredits job may update the deleted and expired credits for a customer in the credits database so that the credit usage history for a customer is up to date. The CleanOpenCarts job may delete any closed transactions and update redeemed credits for a customer in the credits database so that the customer's credit usage history is up to date. The PublishJobs job may move data to the business intelligence system 416.

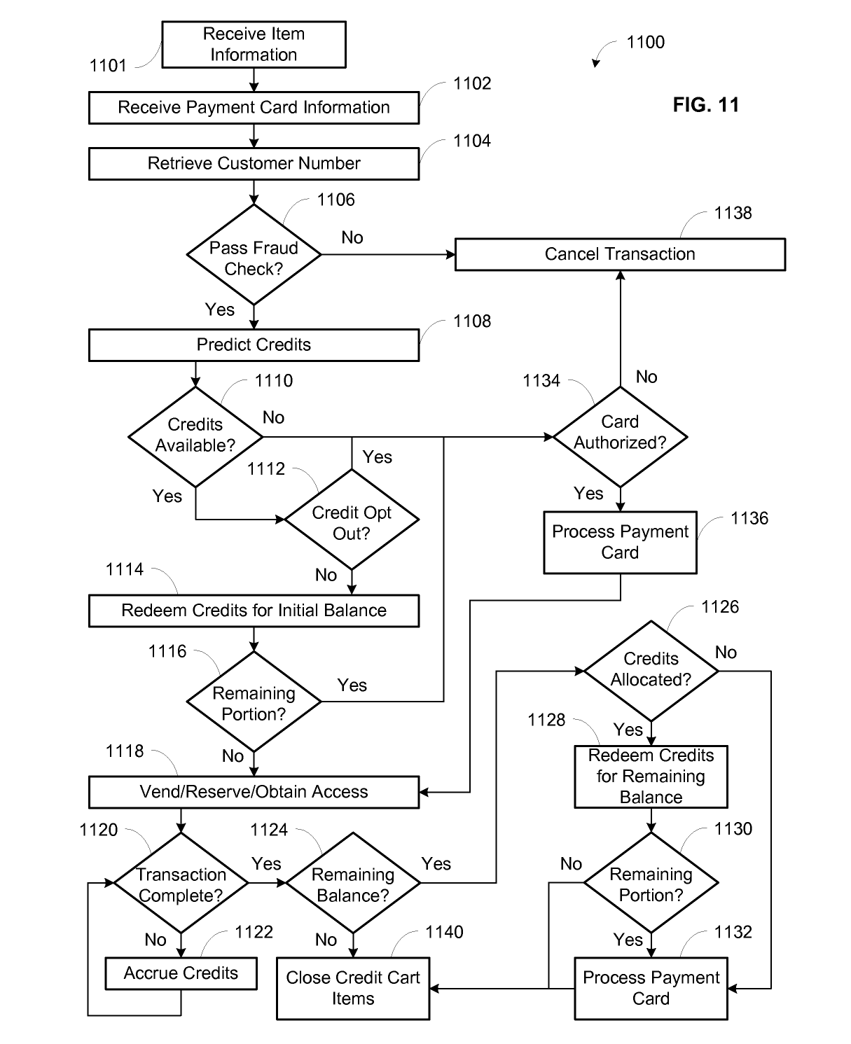

An embodiment of a process 1100 for processing a variable value transaction using credits and/or a payment card is shown in FIG. 11. The process 1100 can result in the redemption of applicable credits and/or the processing of a payment card by the credits system 406 and credits service 502 to satisfy an initial balance and/or a remaining balance associated with the variable value transaction. A piece of media content can be involved in the variable value transaction. In particular, the piece of media content may include a physical media article, such as a DVD, Blu-Ray disc, or video game disc, or a digital media selection, such as streaming video content, video-on-demand content, downloadable video content, streaming video games, downloadable video games, or other digital media content. The variable value transaction can be initiated upon the rental, reservation, or purchase of the piece of media content. In the case of a rental of a media article, the variable value transaction may begin upon vending of the media article from an article dispensing machine 230, and the initial balance may correspond to the price involved with renting the media article for an initial night. The reservation of a media article for later pickup at an article dispensing machine 230 may also incur an initial balance corresponding to an initial night's rental, even if the media article is not timely picked up. Obtaining access to a media selection may initiate the variable value transaction and incur an initial balance.

The remaining balance may be unknown at the start of a variable value transaction and can be calculated upon completion of the variable value transaction. The variable value transaction may be completed, for example, when a rented media article is returned to an article dispensing machine 230. In this case, the remaining balance may correspond to the price involved with keeping the rented media article for one or more extra nights beyond the initial night prior to returning the media article. If the variable value transaction was initiated by a reservation of the media article for later pickup and the media article was not timely picked up, then the variable value transaction may be complete with no remaining balance. If the media article was timely picked up after a reservation, then the variable value transaction is completed when the rented media article is returned to the article dispensing machine 230. A passive sale of a rented media article may also complete a variable value transaction, indicating that the rented media article was not returned by a predetermined time period, such as 25 days for a DVD, 23 days for a Blu-Ray disc, or 30 days for a video game disc. The purchase price of the media article is charged when there is a passive sale of the rented media article. In the case of a media selection, the variable value transaction may be completed when access to the media selection is relinquished.

The process 1100 and the corresponding variable value transaction may be initiated when a customer desires to checkout and rent, reserve, or purchase pieces of media content in their “shopping cart”. The “shopping cart” may have been created by a customer at the article dispensing machine 230, through the API 508, or on the website interface 418. At step 1101, item information for the one or more pieces of media content involved in the variable value transaction may be received by the credits system 406. The item information may be derived from the “shopping cart” created by the customer. The item information received from the “shopping cart” may be handled in the credits system 406 in a credit cart, as described above, for tracking whether the items are open or closed in the variable value transaction.

Payment card information may be received by the identification and authentication controller 402 at step 1102 from the article dispensing machine 230, the API 508, or the website interface 418. The payment card may include a credit card or debit card, and the information from the payment card may be a unique customer identifier, such as the payment card number or hashed version of the payment card number. Based on the payment card information, a customer number may be retrieved at step 1104. The customer number may correspond to a particular customer in the customer profile database 404 and may be retrieved by matching the payment card information to the customer. At step 1106, it is determined whether the customer passes a fraud check. The fraud check includes whether the customer is eligible to initiate the variable value transaction, based on unpaid debts, a history of declined payment cards, appearance on a customer blacklist, and other risk factors. If the fraud check is not passed, then the transaction is cancelled at step 1138 and the customer is not allowed to rent, reserve, or purchase the pieces of media content in the “shopping cart”. In one embodiment, if the fraud check is not passed based on a predetermined item limit for a customer, the customer may be given an opportunity to reduce the number of items involved in the transaction. If the fraud check is passed, then the process continues to step 1108.

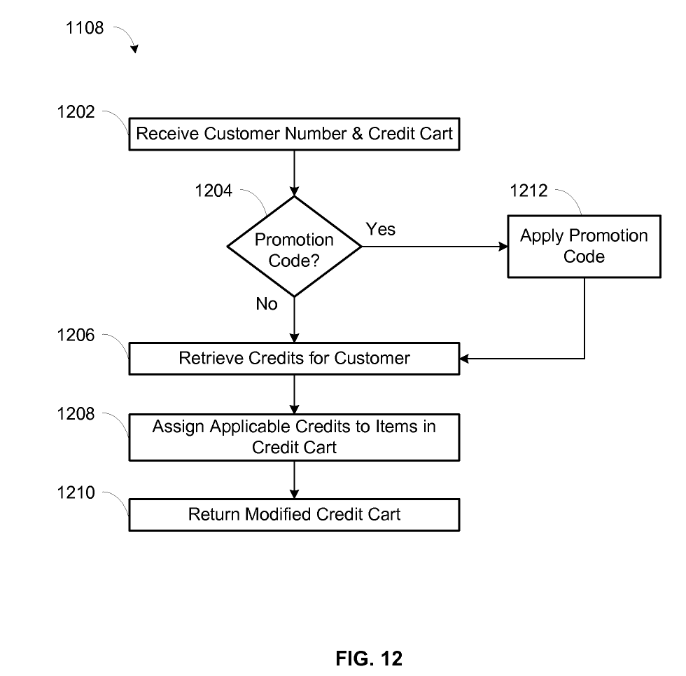

At step 1108, the predicted credits that may be available and applicable to items in the credit cart are determined. The credits service 502 may inspect the items in the credit cart and utilize the credits business rules management system 504 and the credits database 506 to estimate which credits may be assignable to the items. The PredictCredits function in the credits service 502 may be called to perform step 1108. An embodiment of step 1108 is shown in more detail with reference to FIG. 12. At step 1202, the customer number and the credit cart may be received by the credits service 502. The credit cart can include the items involved in the variable value transaction. If a cart discount amount related to a promotion code is present in the credit cart at step 1204, then the promotion code may be applied at step 1212. The promotion code may be a specific monetary amount, such as one dollar, two dollars, or five dollars, and can be applied to the entire credit cart. Promotion codes may be issued by a customer service representative or for marketing promotions. The promotion code may have been entered by the customer at the time of checkout. In one embodiment, a promotion code is applied to media articles in order of precedence of DVDs, Blu-Ray discs, and video game discs. In other embodiments, the cart discount amount related to a promotion code is applied to the item(s) in a credit cart that are less than or equal to the cart discount amount. If an item has a promotion code applied to it, a credit may not be used towards the item. Following application of the promotion code, the process 1108 continues to step 1206. The process 1108 also continues to step 1206 if there is no promotion code present in the credit cart at step 1204.

At step 1206, the credits corresponding to the customer may be retrieved from the credits database 506. The credits may be looked up in the credits database 506 based on the customer number received at step 1202. The credits corresponding to the customer can be assigned to the items in the credit cart, if applicable, at step 1208. The applicability rules for a particular credit can be processed by the credits business rules management system 504 to determine whether to assign the credit to an item in the credit cart. Specifically, the attributes in the credit definition 602 of a particular credit will determine whether the credit is applicable to an item. A credit may be applied to the initial balance or remaining balance of the variable value transaction. In the case of a rental of a piece of media content, this may correspond to the revenue streams of an initial night or extra night, respectively. The credit may also be applied to a non-return/passive sale or a purchase.

The credit may be examined to determine whether the credit is expired, whether the credit is applicable to the particular item type, whether the credit can be applied to the initial balance and/or the remaining balance, and whether the credit may be used at the particular channel the customer is transacting at (e.g., the article dispensing machine 230, the website interface 418, and/or the external partner system 350). For example, if an item in the credit cart is a DVD and an initial night rental, then a credit that is unexpired, applicable to at least DVDs, and that can be used for an initial balance can be assigned as applicable to the item. However, an unexpired credit that is applicable only to Blu-Ray discs or video game discs would not be assigned as applicable to the DVD item.

A credit, if appropriate, can be assigned to applicable items in an order that is beneficial to the customer (e.g., from highest value to lowest value), beneficial to the operator of the article dispensing machine 230, external partner, or content provider (e.g., based on contractual agreements and obligations), or other criteria. For example, a one night rental of a Blu-Ray disc is valued at $1.50, as compared to a one night rental of a DVD valued at $1.00. If the credit is applicable to DVDs and Blu-Ray discs, then the credit would be first assigned as applicable to a Blu-Ray disc in a credit cart. Furthermore, a credit can be applied to applicable items in order of earlier expiration date to later expiration date. Also, credits may not be applied to an initial or remaining balance below a predetermined amount, such as below $1.00, in the interest of giving a customer the best value for a credit. Further examples of applying credits to items in a credit cart are described below. Credits that are assigned in the process 1108 remain in the available state 1002 because the process 1108 only predicts the usage of credits to items in the credit cart. The estimated assignment of credits to items in the credit cart may be returned at step 1210 in the form of a modified credit cart.

Returning to FIG. 11, it is determined whether credits are available to be assigned to items in the credit cart at step 1110. If it is the case that no credits were predicted to be available for assignment to items, then the process 1100 continues from step 1110 to step 1134. Because no credits were predicted to be available, the payment card may be processed to pay for the initial balance of the variable value transaction. At step 1134, the payment card is checked for authorization of its payment capability, such as by communicating with the financial server 305. If the payment card is not authorized at step 1134, then the transaction is cancelled at step 1138. However, if the payment card is authorized at step 1134, then the payment card is processed at step 1136 to pay for the initial balance. In one embodiment, processing of the payment card may include charging or billing an account at the affiliate or external vendor. In another embodiment, processing of the payment card may include using alternative methods of payment, such as PayPal, American Express Serve, Facebook Credits, frequent flyer mile redemption, and the like. Following processing of the payment card at step 1136, an action is taken at step 1118 such as vending of the piece of media content, reservation of the piece of media content for later pickup, or obtaining accessing to the piece of media content. For example, a media article (e.g., DVD, Blu-Ray disc, video game disc) may be vended from an article dispensing machine 230 at step 1118. As another example, a media article may be reserved for later pickup from the article dispensing machine 230 at step 1118. As a further example, access to view or download a media selection may be obtained by the customer at step 1118.

If at least one credit was predicted to be available for assignment to an item at step 1110, then the process 1100 continues to step 1112 and queries as to whether the customer wishes to opt out of using credits for the transaction. A customer may wish to opt out of using credits if the customer is saving credits for a future transaction, for example. If the customer opts out of using credits for the transaction at step 1112, then the payment card may be processed to pay for the initial balance of the variable value transaction. As described above, the payment card may be authorized and processed at steps 1134 and 1136 followed by the action at step 1118, or if the payment card is not authorized, the transaction can be cancelled at step 1138. If a customer opts out of using credits at step 1112, the action at step 1118 (as described above) may be taken following processing of the payment card at step 1136. In addition, in one embodiment, credits will not be accrued at step 1122 or redeemed at step 1128, as described below. Instead, in the case of a customer opt out in this embodiment, a remaining balance of the variable value transaction is satisfied by processing of the payment card at step 1132 since no credits will have been accrued or allocated. In another embodiment, credits may be redeemed for a remaining balance even if a customer opts out of redeeming credits for an initial balance at the beginning of the variable value transaction.

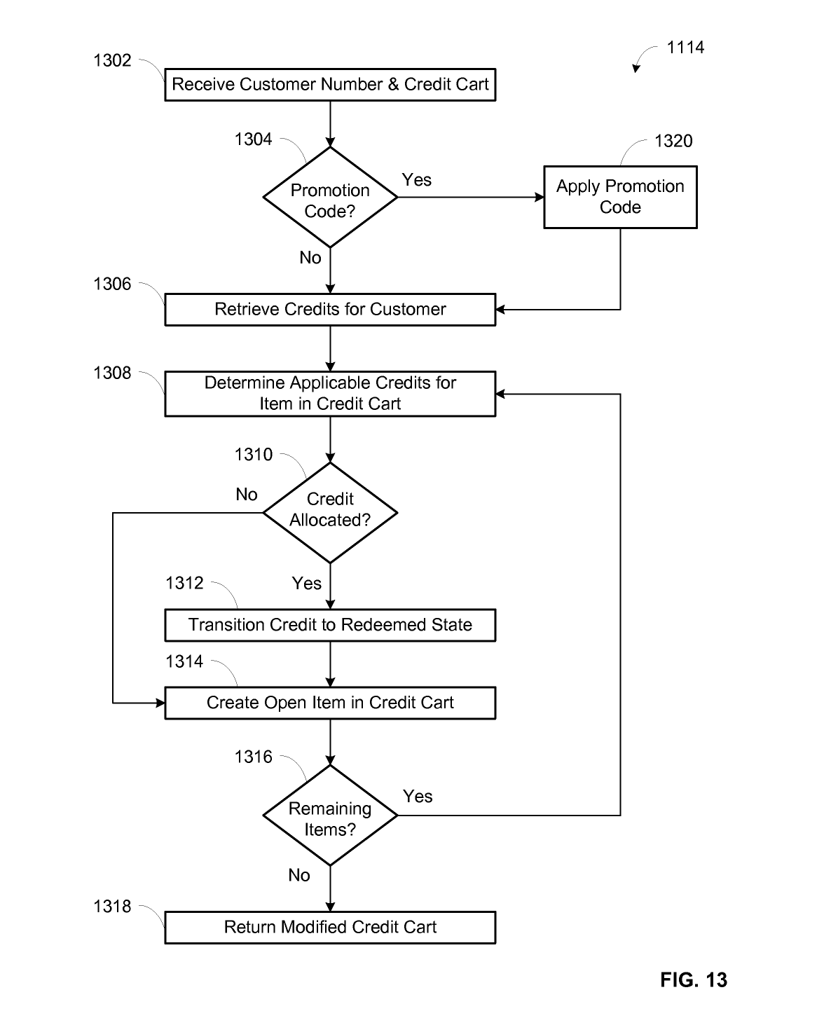

Returning to step 1112, if the customer does not opt out of using credits for the transaction, then the process 1100 continues to step 1114. At step 1114, credits corresponding to the customer may be redeemed for the initial balance of the variable value transaction. The credits service 502 may inspect the items in the credit cart and utilize the credits business rules management system 504 and the credits database 506 to determine which credits to redeem for the items. The RedeemCredits function in the credits service 502 may be called to perform step 1114. An embodiment of step 1114 is shown in more detail with reference to FIG. 13. At step 1302, the customer number and the credit cart may be received by the credits service 502. The credit cart can include the items involved in the variable value transaction. If a cart discount amount related to a promotion code is present in the credit cart at step 1304, then the promotion code may be applied at step 1320 in the same way as described above with reference to step 1212 in FIG. 12. Following application of the promotion code, the process 1114 continues to step 1306. The process 1114 also continues to step 1306 if there is no promotion code present in the credit cart at step 1304.

At step 1306, the credits corresponding to the customer may be retrieved from the credits database 506. The credits may be looked up in the credits database 506 based on the customer number received at step 1302. At step 1308, it can be determined whether the credits corresponding to the customer can be allocated to the items in the credit cart. The applicability rules for a particular credit can be processed by the credits business rules management system 504 at step 1308 to determine whether to allocate the credit to an item in the credit cart. Specifically, the attributes in the credit definition 602 of a particular credit will determine whether the credit is applicable to an item. A credit may be applied to the initial balance or remaining balance of the variable value transaction. In the case of a rental of a piece of media content, this may correspond to the revenue streams of an initial night or extra night, respectively. The credit may also be applied to a non-return/passive sale or a purchase.

The credit may be examined to determine whether the credit is expired, whether the credit is applicable to the particular item type, whether the credit can be applied to the initial balance and/or the remaining balance, and whether the credit may be used at the particular channel the customer is transacting at (e.g., the article dispensing machine 230, the website interface 418, and/or the external partner system 350). For example, if an item in the credit cart is a video game disc and an initial night rental, then a credit that is unexpired, applicable to at least video game discs, and that can be used for an initial balance can be allocated to the item. However, an unexpired credit that is applicable only to Blu-Ray discs would not be allocated to the video game item.

At step 1310, it is determined whether a credit was allocated to an item in the credit cart at step 1308. If a credit was allocated to an item in the credit cart, the particular credit is transitioned from an available state 1002 to a redeemed state 1006 at step 1312. When the credit is in the redeemed state 1006, the credit can no longer be used for other items. An open item is created in the credit cart at step 1314 so that the status of the item can be tracked as long as the variable value transaction remains uncompleted. Step 1314 to create an open item in the credit cart is also performed if it was determined that a credit was not allocated to the item in the credit cart at step 1310. In this case, no credits have been redeemed because there were no credits applicable to the item. In addition, the initial balance of the variable value transaction will have at least a remaining portion because the initial balance is not fully satisfied by the redemption of credits. If there are remaining items in the credit cart at step 1316, then the process 1114 returns to step 1308 to determine applicable credits for the remaining items. If there are no remaining items in the credit cart at step 1316, then the modified credit cart denoting the allocation of credits to items in the credit cart is returned at step 1318.

Returning to FIG. 11, it is determined at step 1116 whether there is a remaining portion of the initial balance after the redemption of credits at step 1114. If there is a remaining portion of the initial balance, then the payment card may be processed to pay for the remaining portion. As described above, the payment card may be authorized and processed at steps 1134 and 1136 followed by the action at step 1118, or if the payment card is not authorized, the transaction can be cancelled at step 1138. Returning to step 1116, if there is no remaining portion of the initial balance that must be paid for, then the process 1100 continues to step 1118 to perform an action such as vending, reserving for later pickup, or obtaining access to a piece of media content.

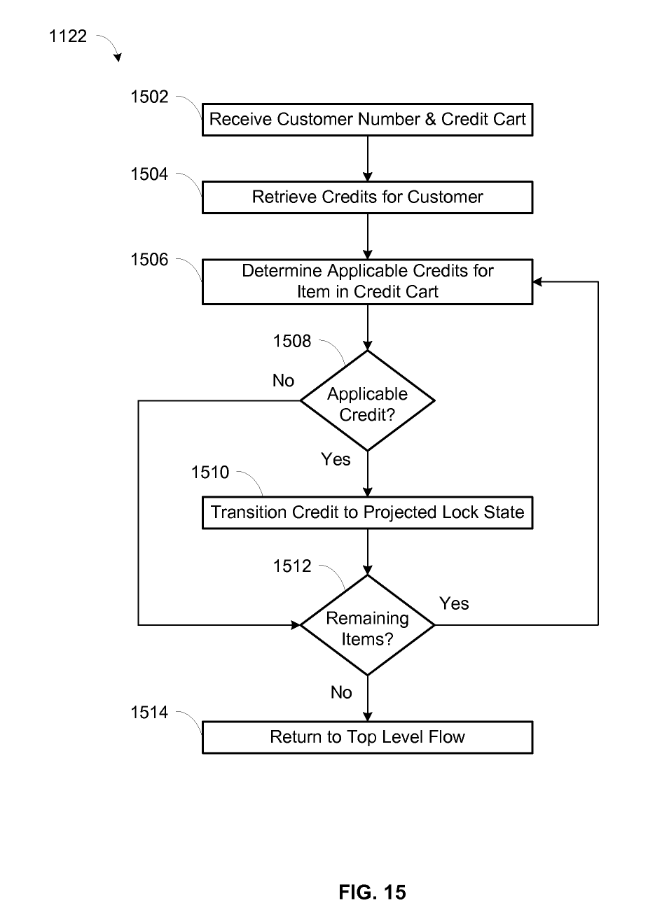

It can be determined at step 1120 whether the variable value transaction is complete. Step 1120 may not occur for one or more hours, days, or other time periods because completion of the transaction may be based on customer decisions. Completion of the variable value transaction includes return of a media article to an article dispensing machine 230, a non-pickup of a reserved media article from the article dispensing machine 230, a passive sale of a media article after a predetermined time period, a relinquishing of access to a media selection, or if it is detected that one of these events has occurred but was not registered with the credits service 502. If the transaction is determined to not be completed at step 1120, then credits may be accrued on a periodic basis for predicting usage of credits to pay for a remaining balance of the transaction at step 1122. One or more credits may be allocated to items in the transaction and placed in a projected lock state 1004 at step 1122. These credits, while allocated to potentially pay for the remaining balance of the transaction, would not be redeemed until step 1128, if the accrual is correct. Accrual of credits may take into account the local time zones where the variable value transaction originated and becomes completed. In particular, it is assumed that the originating time zone will be the same as the completed time zone while credits are accrued. However, if the transaction is completed in a different time zone than the originating time zone, the credits service 502 can redeem or not redeem an accrued credit, according to the time zone differences. An embodiment of step 1122 is described in more detail below with reference to FIG. 15.

However, if the transaction is determined to be completed at step 1120, then the process 1100 continues to step 1124 where it is determined whether there is a remaining balance of the variable value transaction. A remaining balance may occur, for example, when a piece of media content involved in the variable value transaction has been kept for longer than the period allowed by payment of the initial balance, such as one night. If there is no remaining balance at step 1124, then the open item in the credit cart corresponding to the piece of media content in the transaction may be closed at step 1140. However, if there is a remaining balance at step 1124, then the process 1100 continues to step 1126 where it is determined whether any credits have been allocated for the open items in the credit cart. As mentioned above, credits may be accrued and allocated at step 1122 to satisfy a remaining balance of the variable value transaction. If there are no credits allocated at step 1126, then the remaining balance may be satisfied by processing the payment card at step 1132. The open item in the credit cart may then be closed at step 1140.

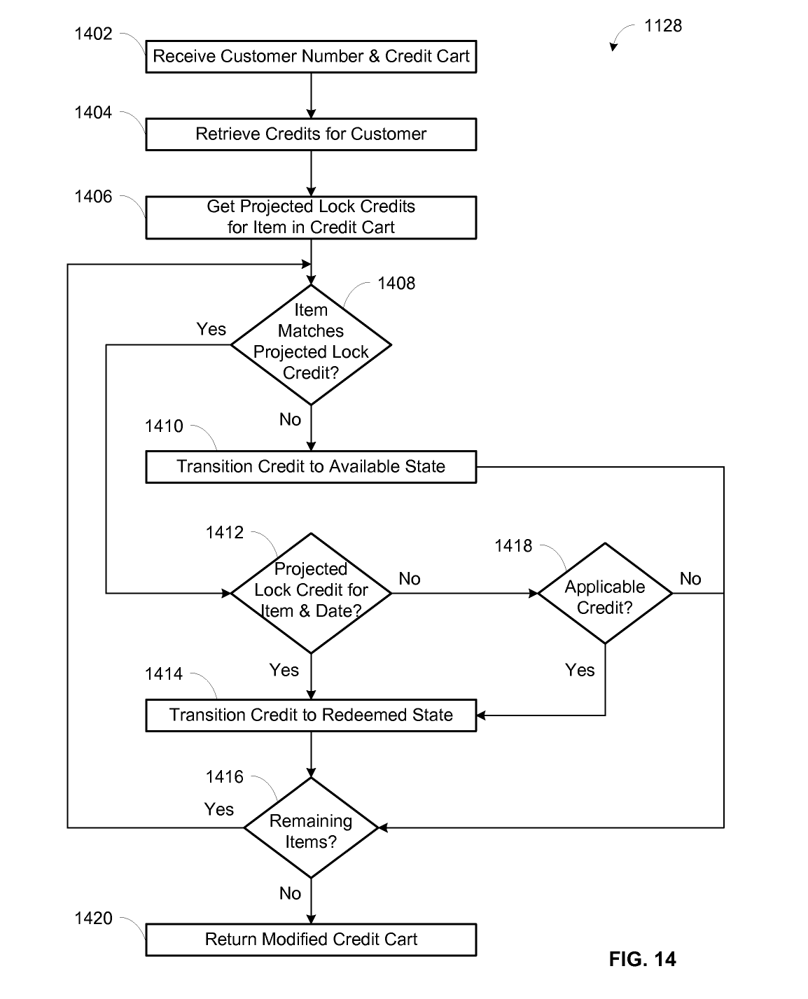

However, if there are allocated credits at step 1126, then at step 1128, the allocated credits may be redeemed to satisfy some or all of the remaining balance of the variable value transaction. The credits service 502 may inspect the open items in the credit cart and utilize the credits business rules management system 504 and the credits database 506 to determine which credits to redeem for the items. The RedeemCredits function in the credits service 502 may be called to perform step 1128. An embodiment of step 1128 is shown in more detail with reference to FIG. 14. At step 1402, the customer number and the credit cart may be received by the credits service 502. The credit cart can include the items involved in the variable value transaction that have a remaining balance that needs to be satisfied. At step 1404, the credits corresponding to the customer may be retrieved from the credits database 506. The credits may be looked up in the credits database 506 based on the customer number received at step 1402.

At step 1406, the credits in a projected lock state 1004 that correspond to the open items in the credit cart may be determined from the credits for the customer retrieved at step 1404. Credits may have been transitioned to a projected lock state 1004 at step 1122 of the process 1100 due to the accrual of credits when the variable value transaction was not yet complete. At step 1408, it is determined whether an item in the credit cart matches a credit that is in a projected lock state 1004. If there are no items that match a credit that is in the projected lock state 1004, then the credit is transitioned to an available state 1002 at step 1410. In this case, the credit was erroneously transitioned to the projected lock state 1004 and becomes available again for future usage. The credit may have been erroneously transitioned to the projected lock state 1004 if, when accruing credits at step 1122, the credits service 502 believes that items in the variable value transaction are still open. This may occur, for example, if an article dispensing machine 230 that receives a return of a rented media article is not in communication with the credits service 502 at the time of the return, due to a network interruption or other interruption in communication. Following step 1410, the process 1128 continues to step 1416 to determine if there are remaining items in the credit cart.

If there are items that match a credit in the projected lock state 1004 at step 1408, then at step 1412, it is determined whether the credit in the projected lock state 1004 corresponds to a particular item and particular date. As discussed above, a credit may be in the projected lock state 1004 if the credit had been previously accrued and predicted to be used to satisfy a remaining balance of the variable value transaction. If there is a credit in the projected lock state 1004 that corresponds to a particular item in the credit cart and a particular date, then the credit may be transitioned from the projected lock state 1004 to a redeemed state 1006 at step 1414. However, if there is not a credit in the projected lock state 1004 that corresponds to a particular item in the credit cart and a particular date, then the process 1128 may continue to step 1418.

At step 1418, it may be determined whether there is a credit in the available state 1002 that may be applicable to the particular item in the credit cart for the particular date. The applicability rules for a credit can be processed by the credits business rules management system 504 at step 1418 to determine whether to allocate the credit to the particular item in the credit cart for the particular date. Specifically, the attributes in the credit definition 602 of a particular credit will determine whether the credit is applicable to an item, as described above in reference to step 1308 of the process 1114. If there are no credits which are applicable to the particular item in the credit cart for the particular date at step 1418, then the process 1128 continues to step 1416 to determine if there are remaining items in the credit cart. In this case, some or all of the remaining balance of the variable value transaction may need to be satisfied by processing a payment card. However, if there is a credit that is applicable to the particular item in the credit cart for the particular date at step 1418, then that credit is transitioned from an available state 1002 to a redeemed state 1006 at step 1414. Following step 1414, the process 1128 continues to step 1416 to determine if there are remaining items in the credit cart. At step 1416, if there are remaining items in the credit cart, then the process 1128 returns to step 1408 to determine whether the remaining items match credits in a projected lock state 1004. If there are no remaining items in the credit cart at step 1416, then the modified credit cart denoting the allocation of credits to items in the credit cart is returned at step 1420.

Returning to FIG. 11, it is determined at step 1130 whether there is a remaining portion of the remaining balance of the variable value transaction after the redemption of credits at step 1128. There may be a remaining portion of the remaining balance if, for example, an insufficient number of credits were redeemed at step 1128 to satisfy the remaining balance. If there is a remaining portion of the remaining balance, then the payment card may be processed to pay for the remaining portion at step 1132. The open items in the credit cart may be closed at step 1140 following step 1132, or if there is not a remaining portion of the remaining balance at step 1130.

An embodiment of a process 1122 for accruing credits in a variable value transaction is shown in FIG. 15. The process 1122 corresponds to step 1122 of the process 1100 shown in FIG. 11. Credits may be accrued on a periodic basis with the process 1122 for predicting usage of credits to pay for a remaining balance of the variable value transaction that is uncompleted. One or more credits may be allocated to items in the transaction and placed in a projected lock state 1004 using the process 1122. These projected lock credits may or may not be redeemed to satisfy a remaining balance, such as at steps 1126 and 1128 described above in FIG. 11. The UpdateAccruals function in the credits service 502 may be called to perform the process 1122. At step 1502, the customer number and the credit cart may be received by the credits service 502. The credit cart can include the items involved in the variable value transaction that is not yet completed. At step 1504, the credits corresponding to the customer may be retrieved from the credits database 506. The credits may be looked up in the credits database 506 based on the customer number received at step 1502.

At step 1506, it can be determined whether the credits corresponding to the customer can be allocated to the items in the credit cart. The applicability rules for a particular credit can be processed by the credits business rules management system 504 at step 1506 to determine whether to allocate the credit to an item in the credit cart. Specifically, the attributes in the credit definition 602 of a particular credit will determine whether the credit is applicable to an item. In the context of the process 1122 related to accrual of credits, even if a credit is applicable to an item, it may or may not be redeemed to satisfy the remaining balance of the variable value transaction, but instead will be placed in a projected lock state 1004. At step 1508, it is determined whether a credit was allocated to an item in the credit cart at step 1506. If a credit was allocated to an item in the credit cart, the particular credit is transitioned from an available state 1002 to a projected lock state 1004 at step 1510. When the credit is in the projected lock state 1004, the credit cannot be used for other items but it may be redeemed in the future to satisfy the remaining balance. A credit in the projected lock state 1004 may alternatively be transitioned back to the available state 1002, such as at steps 1408 and 1410 in FIG. 14 described above.

Following step 1510, the process 1122 continues to step 1512 to determine if there are remaining items in the credit cart. The process 1122 also continues to step 1512 if there are no applicable credits allocated at step 1508. At step 1512, if there are remaining items in the credit cart, then the process 1122 returns to step 1506 to determine whether there are applicable credits for the remaining items in the credit cart. If there are no remaining items in the credit cart at step 1512, then the process 1122 is complete at step 1514 and returns to the process 1100 of FIG. 11. In particular, following the process 1122, it is determined at step 1120 of FIG. 11 whether the variable value transaction is complete, as described above. The process 1122 may be executed periodically while the transaction is uncompleted, such as nightly using the credit job described above.

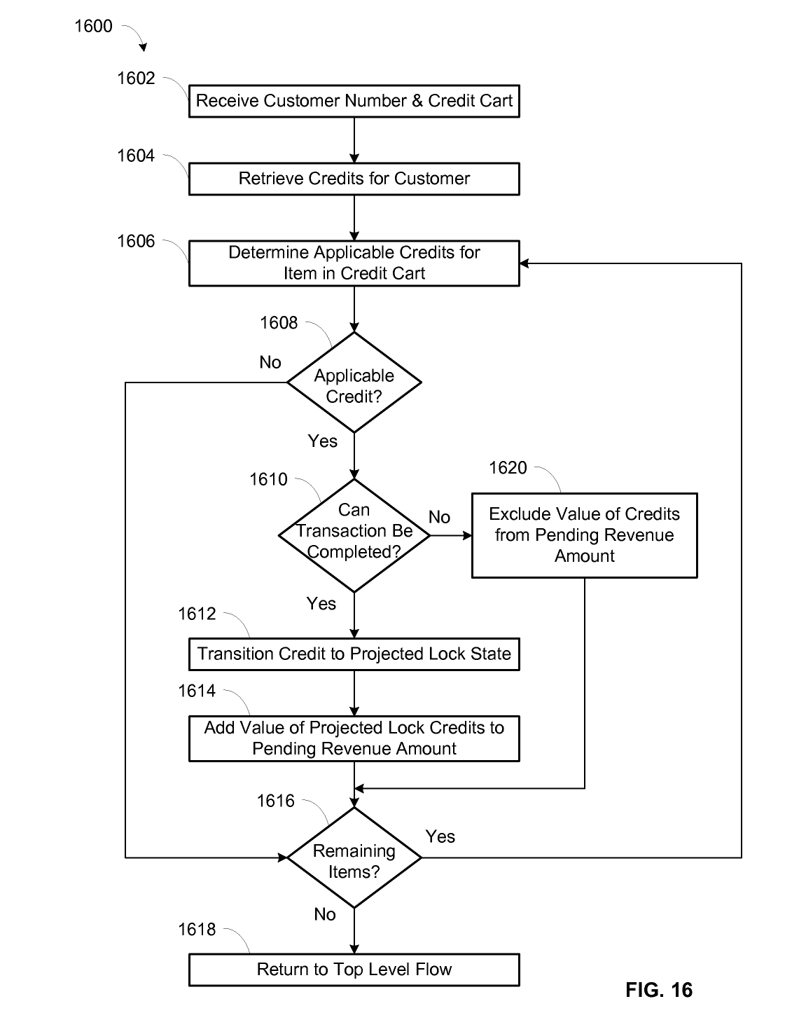

In another embodiment, a process 1600 for accruing credits in a variable value transaction is shown in FIG. 16. The process 1600 may correspond to step 1122 of the process 1100 shown in FIG. 11. Credits may be accrued on a periodic basis with the process 1600 for predicting usage of credits to pay for a remaining balance of the variable value transaction that is uncompleted. One or more credits may be allocated to items in the transaction and placed in a projected lock state 1004 using the process 1600. Accrual of credits in a variable value transaction, as in the process 1600, may also affect a pending revenue amount. The pending revenue amount is an estimated amount of revenue that is expected but not yet recognized due to the variable value transaction being uncompleted. The business intelligence system 416, for example, may need to have the total pending revenue amount related to all open transactions on a periodic basis so that financial information is as accurate as possible. The UpdateAccruals function in the credits service 502 may be called to perform the process 1600.

At step 1602, the customer number and the credit cart may be received by the credits service 502. The credit cart can include the items involved in the variable value transaction that is not yet completed. At step 1604, the credits corresponding to the customer may be retrieved from the credits database 506. The credits may be looked up in the credits database 506 based on the customer number received at step 1602. At step 1606, it can be determined whether the credits corresponding to the customer can be allocated to the items in the credit cart. The applicability rules for a particular credit can be processed by the credits business rules management system 504 at step 1606 to determine whether to allocate the credit to an item in the credit cart. In the context of the process 1600 related to accrual of credits, even if a credit is applicable to an item, it may or may not be redeemed to satisfy the remaining balance of the variable value transaction, but instead will be placed in a projected lock state 1004.

At step 1608, it is determined whether a credit was allocated to an item in the credit cart at step 1606. If a credit was allocated to an item in the credit cart, it is determined whether the transaction can be completed by a customer at step 1610. In some cases, a customer may not be able to complete a variable value transaction due to circumstances beyond the customer's control. The accrual of credits in the process 1600 for the remaining balance of the transaction, as well as the pending revenue amount, can be adjusted at step 1620 so that the credits are not necessarily placed in a projected lock state 1004. For example, if a customer only has access to an article dispensing machine 230 in a location that is only accessible Monday through Friday, then the accrual of credits may be excluded at step 1620 for Saturday and Sunday for rentals from that particular article dispensing machine 230. In effect, the remaining balance of a variable value transaction would not increase on the days the article dispensing machine 230 is inaccessible to the customer. Also, credits that are not accrued while the transaction remains open would not be added to the pending revenue amount. Accordingly, if it is determined that the transaction cannot be completed by the customer at step 1610, then the value of the credits that would have been placed in a projected lock state 1004 is excluded from the pending revenue amount at step 1620. In addition, these credits remain in an available state 1002.

However, if it is determined at step 1610 that the transaction can be completed by the customer, the credit is transitioned from an available state 1002 to a projected lock state 1004 at step 1612. When the credit is in the projected lock state 1004, the credit cannot be used for other items but it may be redeemed in the future to satisfy the remaining balance. A credit in the projected lock state 1004 may alternatively be transitioned back to the available state 1002, such as at steps 1408 and 1410 in FIG. 14 described above. Following step 1612, the process 1600 continues to step 1614 where the value of the projected lock credit may be added to the pending revenue amount. Although a credit in the projected lock state 1004 is not yet redeemed, the value of the credit may be added to the pending revenue amount since the credit is predicted to be redeemed for some or all of the remaining balance of the variable value transaction. When the variable value transaction is completed and closed, then the pending revenue amount may be recognized as recognized revenue.

The value of a credit may vary depending on factors such as the product to which the credit is applied, taxes, the source of the credit, and other factors. For example, a Blu-Ray disc may be valued at $1.50 for one rental night, as compared to a DVD which is valued at $1.00 for one rental night. A source of the credit may include an external partner (e.g., a cable television operator, a satellite television service provider, an IPTV provider, an online gaming and digital media delivery service, a website, a movie studio, a television network, a game publisher, a retailer), an internal marketing department, or other source. For example, the external partner may pay more for a credit provided to a customer than the internal marketing department pays for a credit. As another example, the external partner may purchase credits in bulk for resale or distribution to its customers at a discounted price per credit as compared to the value of the credit to the customer. Accordingly, while the value of a credit from the perspective of a customer relates to the product involved in a transaction, the value of a credit from the perspective of an external partner may differ, e.g., may be lower. With regards to steps 1614 and 1620 described above, this possible variance in the value of accrued credits (and included or excluded in pending revenue) should be accounted for when determining pending revenue amounts.

Following step 1614, the process 1600 continues to step 1616 to determine if there are remaining items in the credit cart. The process 1600 also continues to step 1616 if there are no applicable credits allocated at step 1608. At step 1616, if there are remaining items in the credit cart, then the process 1600 returns to step 1606 to determine whether there are applicable credits for the remaining items in the credit cart. If there are no remaining items in the credit cart at step 1616, then the process 1600 is complete at step 1618 and returns to the process 1100 of FIG. 11. In particular, following the process 1600, it is determined at step 1120 of FIG. 11 whether the variable value transaction is complete, as described above. The process 1600 may be executed periodically while the transaction is uncompleted, such as nightly using the credit job described above.

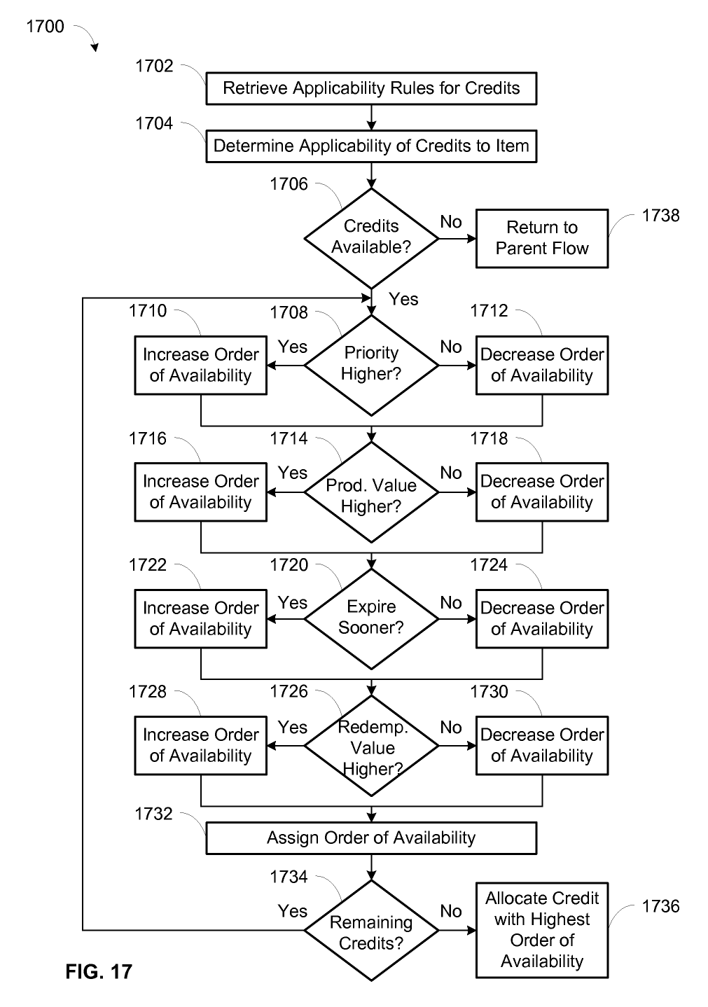

An embodiment of a process 1700 for optimizing the redemption of credits in a variable value transaction is shown in FIG. 17. The process 1700 may correspond to the step of determining applicable credits for items in a credit cart, as in step 1308 of the process 1114 shown in FIG. 13, step 1418 of the process 1128 in FIG. 14, step 1506 of the process 1122 in FIG. 15, and step 1606 of the process 1600 in FIG. 16. The process 1700 may result in the allocation of credits for redemption in a particular order to satisfy an initial balance or remaining balance of a variable value transaction. The selection of which credits to redeem and in which order to redeem the credits may be based on the best value for the customer as well as to optimize the recognition of revenue. For example, a first external partner may purchase credits to offer as part of a credit subscription, while a second external partner may purchase credits to offer as standalone promotional credits offered to customers. The first external partner may pay a lesser amount for each of the credits that will be part of a credit subscription as opposed to the promotional credits purchased by the second external partner because the first external partner is purchasing a greater quantity of credits. During a variable value transaction, the promotional credits may be optimized so that they are redeemed prior to the subscription credits, resulting in sooner recognition of a greater amount of revenue.

Credit redemption criteria including a redemption priority, a product value, an expiration date, and/or a redemption value of a credit can be utilized to determine the order of availability that denotes whether a particular credit should be redeemed prior to or after another credit. First, the redemption priority for a credit may be predetermined, whether the credit originated from a credit subscription or from another source. Certain credits may be assigned a higher redemption priority, for example, if those credits would result in the recognition of a greater amount of revenue. A credit with a higher redemption priority may be assigned a higher order of availability. The redemption priority for credits may be based on a variety of factors, including the revenue shares of the external partners involved (e.g., movie studio, video game developer, retailer, etc.), contractual agreements with the external partners (e.g., the external partner may or may not pay varying amounts for credits), strategic value (e.g., if a credit is related to a customer promotion for certain targeted attributes), customer benefit (e.g., if the credit could be used for a higher value item rather than a lower value item), and other factors.

In one embodiment, the redemption priority of credits may be in the order of: (1) if a credit has a subscription identification number, so that credits created with a subscription are redeemed prior to manually created credits, e.g., customer service credits; (2) effective date of a credit, so that older effective dates are redeemed first; (3) expiration date of a credit, so that credits expiring sooner are redeemed first; (4) revenue stream priority, e.g., initial night-applicable credits before extra night-applicable credits; and (5) product type priority, e.g., Blu-Ray-applicable credits before DVD-applicable credits. The order of redemption priority may be configurable and changed to a different order at any time.

Second, the product value of a particular piece of media content may be based on the price that a customer would pay during a transaction involving that piece of media content. For example, the price of a rental night for a DVD may be $1.00, the price of a rental night for a Blu-Ray disc may be $1.50, and the price of a rental night for a video game disc may be $2.00. A credit that can be applied to a higher product value may be assigned a higher order of availability so that a customer receives a greater value for the credit when the credit is redeemed. Third, the expiration date of a credit may play a role in a credit's order of availability. If a first credit will expire sooner than a second credit, then the first credit may be assigned a higher order of availability so that the first credit can be redeemed before it expires and so that the customer does not lose the credit without using it. Finally, the redemption value of a credit may be used to determine the order of availability of a credit. The redemption value can be the amount an external partner pays for the credit. If the redemption value of a first credit is higher than the redemption value of another credit, the first credit may be assigned a higher order of availability. In one embodiment, the redemption value, e.g., the amount received for reimbursement from an external partner for the user of credit, may be involved with the optimization of the redemption of credits. The redemption value may be calculated when the credit is redeemed.

An advantage of optimizing the redemption of credits is that the various factors and their weighting, as described above, may be adjusted according to business needs and goals. In one embodiment, the redemption priority of a credit and the product value of a particular piece may be the primary factors that are weighted more heavily to ensure an optimal user experience. In other embodiment, the factors may be weighted more equally.

At step 1702, the applicability rules for the credits corresponding to a customer may be retrieved from the credits database 506. The applicability rules may be processed by the credits business rules management system 504 to determine the order of availability of credits and whether to allocate a particular credit to an item in the credit cart. The applicability of the credits to a particular item in a credit cart may be determined at step 1704 based on the retrieved applicability rules. Specifically, the attributes in the credit definition 602 of a particular credit will determine whether the credit is applicable to the particular item type, e.g., DVD, Blu-Ray disc, video game disc, media selection, etc. At step 1706, it is determined whether any credits are available for the particular item in the credit cart. If there are no credits available for the particular item at step 1706, then the process 1700 is complete at step 1738 and returns to the parent flow from where the process 1700 was entered, e.g., the process 1114 shown in FIG. 13, the process 1128 in FIG. 14, the process 1122 in FIG. 15, or the process 1600 in FIG. 16. If there are credits available at step 1706, then the process 1700 continues to step 1708 and examines the credit redemption criteria of the applicable credits that were determined at step 1704.

At step 1708, if the redemption priority of the applicable credit being examined is higher than the redemption priority of the other applicable credits, then the order of availability for that applicable credit can be increased at step 1710. If the redemption priority of the applicable credit being examined is the same or lower than the redemption priority of the other applicable credits, then the order of availability for that applicable credit can be decreased at step 1712. The process 1700 continues to step 1714 following step 1710 or step 1712. At step 1714, if the product value of the applicable credit being examined is higher than the product value of the other applicable credits, then the order of availability for that applicable credit can be increased at step 1716. However, if the product value of the applicable credit being examined is the same or lower than the product value of the other applicable credits, then the order of availability for that applicable can be decreased at step 1718. The process 1700 continues to step 1720 following step 1716 or step 1718.

At step 1720, if the expiration date of the applicable credit being examined is sooner than the expiration dates of the other applicable credits, then the order of availability for that applicable credit can be increased at step 1722. If the expiration date of the applicable credit being examined is the same or later than the expiration date of the other applicable credits, then the order of availability for that applicable credit can be decreased at step 1724. The process 1700 continues to step 1726 following step 1722 or step 1724. At step 1726, if the redemption value of the applicable credit being examined is higher than the redemption value of the other applicable credits, then the order of availability for that applicable credit can be increased at step 1728. However, if the redemption value of the applicable credit being examined is the same or lower than the redemption value of the other applicable credits, then the order of availability for that applicable credit can be decreased at step 1730. The process 1700 continues to step 1732 following step 1728 or step 1730.

The order of availability determined by steps 1708 through 1730 may be assigned at step 1732. The order of availability may be a numerical or other denotation of the preferred redemption sequence for a credit as compared to other credits in order to optimize revenue recognition and value to the customer, as described above. If there are remaining applicable credits at step 1734 that should be assigned an order of availability, then the process 1700 returns to step 1708 and examines the next applicable credit. If there are no remaining applicable credits at step 1734, then at step 1736, the credit with the highest assigned order of availability is allocated to the item in the credit cart. If the process 1700 is executed for step 1308 of FIG. 13 or step 1418 of FIG. 14, the allocated credit may later be redeemed for the initial balance or remaining balance, respectively, in the variable value transaction. If the process 1700 is executed for step 1506 of FIG. 15 or step 1606 of FIG. 16, the allocated credit may later be accrued and placed in a projected lock state 1004 at step 1510 or step 1612, respectively. The credit may be subsequently redeemed in the process 1128 for the remaining balance when a variable value transaction has been completed. When a credit is redeemed for an item in a variable value transaction, the items in the credit cart may also be sorted by a particular priority in order to optimize the redemption of credits. In one embodiment, the items may be sorted in the order of: (1) date the item was placed in the credit cart; (2) revenue stream; (3) item discount amount; (4) product type; and (5) item identification number. This order may be configurable and changed to a different order at any time.

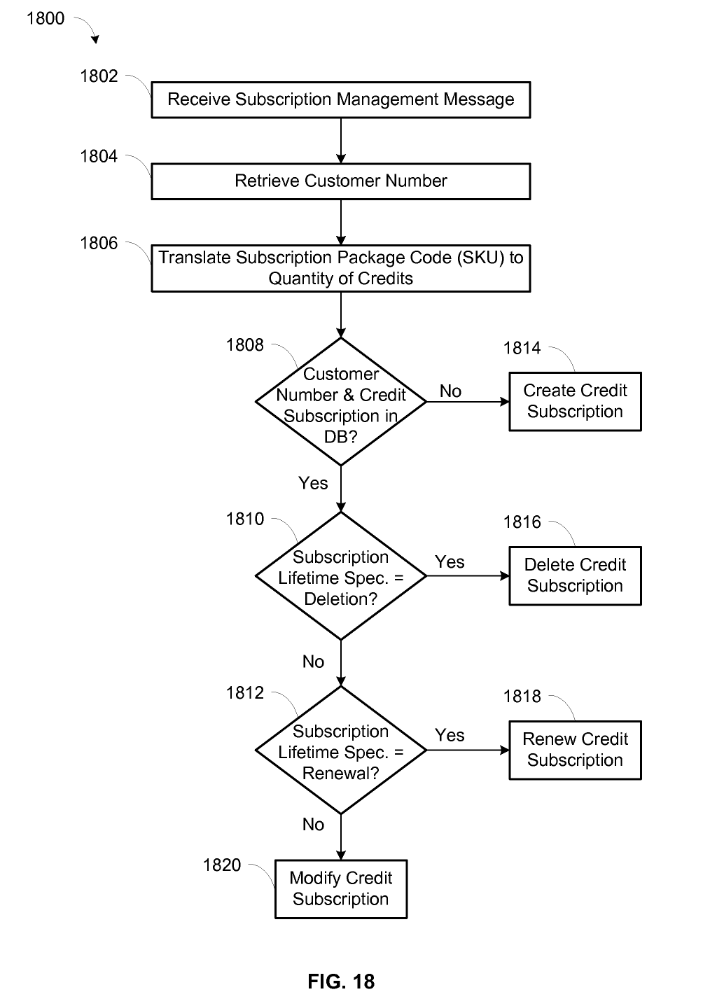

An embodiment of a process 1800 for managing credit subscriptions is shown in FIG. 18. The process 1800 can result in the creation, renewal, modification, or deletion of credit subscriptions corresponding to a customer. A credit subscription can be a one-time or recurring issuance of a quantity of one or more credits to a customer. The credits may be redeemed and/or accrued to satisfy some or all of an initial balance or remaining balance of a variable value transaction, as described above. The variable value transaction may involve a piece of media content. Each of the credits in a credit subscription may have a predetermined validity duration specifying when the credits may be redeemed and/or accrued. The length of the predetermined validity duration may be defined in a credit definition.

A credit subscription can be managed through the subscription loader 510 internally or by an external partner of the external partner system 350. Subscription management messages can be received by the subscription loader 510 that contain attributes related to the management of credit subscriptions for customers. A credit subscription may be created, renewed, modified, or deleted based on the attributes contained in a subscription management message. The CreateSubscription, UpdateSubscriptionExpiration, UpgradeDowngradeSubscription, and/or CancelSubscription functions in the credits service 502 may be called by the subscription loader 510 to perform all or part of the process 1800. The functions of the batch subscription namespace may also be called to perform all or part of the process 1800. Billing and refunds related to the creation, renewal, modification, or deletion of a credit subscription may be handled by the credits service 502 in conjunction with the external partner system 350 (e.g., in the case where an account at the external partner is charged) and/or the financial server 305.

Credits in a credit subscription can be created so that the credits are issued once and expire when the expiration dates of the credits are reached. For example, an external partner system 350 may transmit a subscription management message to the subscription loader 510 to create a credit subscription for a customer that includes a one-time issuance of credits. Credits may also be created in a credit subscription so that the credits are issued and automatically renew on a periodic basis when the previously issued credits expire. For example, a single subscription management message from an external partner system 350 may contain attributes that instruct the subscription loader 510 to generate credits for the customer on a periodic basis. In another embodiment, subscription management messages may be periodically transmitted to the subscription loader 510 that instruct the renewal of an existing credit subscription. In this way, varying business types, models, workflows, and processes can be accommodated. An advantage of this scheme is that a new external partner system 350 can be added to or replace an existing external partner system 350 without any disruption to customers and the credits service 502.

As an example, an external partner may directly bill a customer for a credit subscription, and may wish to delay creation of the credit subscription until the customer is successfully billed. In this case, once payment is collected from the customer, the external partner can transmit a subscription management message to create and/or renew the credit subscription for the customer. The external partner may also periodically transmit such a subscription management message in order to perform manual renewals of the credit subscription. As another example, an external partner may have a customer program with loyalty tiers that grant varying amounts of credits to customers. If a customer in a first tier is granted three credits per month, the external partner may transmit a subscription management message that instructs the subscription loader 510 to create and renew the credits for the customer on a periodic basis until another subscription management message instructs the modification or deletion of the credit subscription. In this example, modification of the credit subscription may occur if the customer changes to another loyalty tier and deletion of the credit subscription may occur if the customer leaves the customer program.

At step 1802 of the process 1800, a subscription management message may be received by the subscription loader 510. The external partner system 350 may transmit the subscription management message to the subscription loader 510 or the subscription management message may be created internally in the subscription loader 510. The subscription management message may include a customer number, a subscription package code, and a subscription lifetime specification. The customer number may uniquely identify the customer and can include a customer shared key that is known to both the external partner system 350 and the customer profile database 404. Other unique identifiers of the customer may also be used as the customer number. The subscription package code may identify a particular credit subscription package, credit packages, and/or credit definitions, and can include a vendor SKU code or other identifier. Examples of vendor SKU codes, credit packages, and credit definitions are described above with reference to FIGS. 6, 7, 8, and 9. The subscription lifetime specification may include a start date and/or an end date that denote when a credit subscription is to begin and/or end, respectively. The subscription management message may be an XML file or other suitable format.

The customer number that uniquely identifies the customer may be retrieved at step 1804. If the customer number can directly identify a customer in the customer profile database 404, the customer number may be retrieved from the subscription management message itself. However, the customer number in the subscription management message may be a customer shared key or other identifier that cannot directly identify a customer in the customer profile database 404. In this case, the credits service 502 can look up the customer number in the customer profile database 404 based on the customer shared key. Once the customer number is looked up, the customer number may be transmitted back to the credits service 502 and the subscription loader 510 and the process 1800 can continue.

The subscription package code may be translated to a particular quantity of credits for the credit subscription at step 1806. As described above, the subscription package code, e.g., vendor SKU code, may refer to one or more credit packages, and the credit packages may refer to one or more quantities of one or more credit definitions. The subscription management message specifies the subscription package code when creating, updating, and/or deleting one or more credits involved in a credit subscription corresponding to a customer. The subscription package code may be known and used by more than one external partner and/or external partner system 350. In performing step 1806, the subscription loader 510 may request that the credits service 502 look up the credit packages and/or credit definitions that correspond to the subscription package code. Once the credits service 502 knows the quantity of particular credits related to the subscription management message, the process 1800 may continue to step 1808.

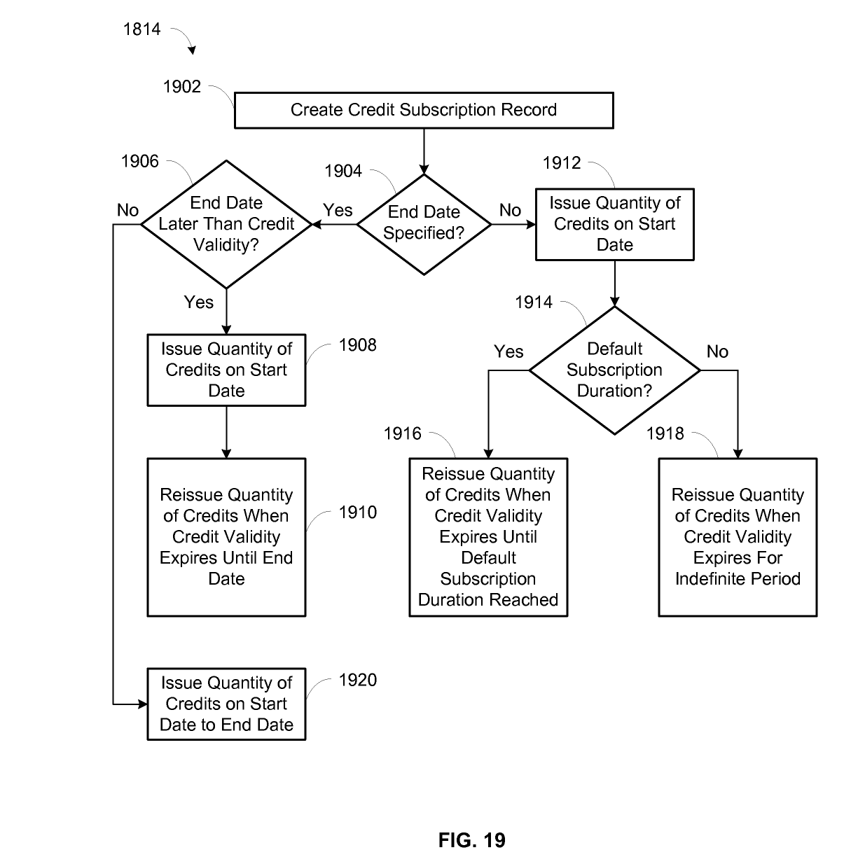

At step 1808, the credits service 502 may determine if the customer number and the credit subscription referred to in the subscription management message already exist in the credits database 506 for the customer. If the customer number and the credit subscription do not exist in the credits database 506 for the customer, then the credit subscription may be created at step 1814, such as by calling the CreateSubscription function. An embodiment of step 1814 is shown in more detail with reference to FIG. 19. At step 1902, a credit subscription record may be created in the credits database that corresponds to the customer. Attributes of the created credit subscription may be stored in the credit subscription record later in the process 1814. At step 1904, it is determined whether the subscription lifetime specification specifies an end date to the credit subscription. An end date may be specified when requesting a specific duration of the credit subscription, for example. In contrast, an end date may not be specified when requesting renewal of credits in the credit subscription for an indefinite period of time or until a maximum default subscription duration is reached.

If an end date is specified in the subscription lifetime specification at step 1904, then at step 1906, it is determined whether the specified end date is later than the predetermined validity duration of the credits added to the start date. If the specified end date is not later than the predetermined validity duration of the credits added to the start date, then at step 1920, the credits service 502 may issue the quantity of credits so that the credits are valid starting from the specified start date of the credit subscription to the specified end date of the credit subscription. For example, if the start date is Jun. 30, 2011, a credit has a predetermined validity duration of one month, and the specified end date is Jul. 31, 2011, then the credit in the credit subscription will be issued on the start date of Jun. 30, 2011 and will be valid until the end date of Jul. 31, 2011.

However, if the specified end date is later than the predetermined validity duration of the credits added to the start date at step 1906, then at step 1908, the credits service 502 may issue the quantity of credits so that the credits are valid starting from the specified start date until the predetermined validity duration of the credits expires. When the predetermined validity duration of the credits expires, then at step 1910, the credits service 502 may reissue the quantity of credits on a periodic basis until the specified end date is reached. The periodic basis may be based on the predetermined validity duration of the credits involved in the credit subscription. The quantity of credits can be reissued each time the predetermined validity duration of the credits expires. For example, if the start date is Jun. 30, 2011, a credit has a predetermined validity duration of one month, and the specified end date is Dec. 31, 2011, then the credit in the credit subscription will be issued on the start date of Jun. 30, 2011 and every month until the end date of Dec. 31, 2011 is reached.

Returning to step 1904, if an end date is not specified in the subscription lifetime specification, then at step 1912, the quantity of credits may be issued by the credits service 502 so that the credits are valid starting from the specified start date. At step 1914, it is determined whether a default subscription duration has been set. A default subscription duration may denote a specific length of time that a credit subscription may last for when an end date has not been specified in the subscription lifetime specification. If a default subscription duration has been set, then at step 1916, the credits service 502 may reissue the quantity of credits on a periodic basis until the default subscription duration is reached. The periodic basis may be based on the predetermined validity duration of the credits involved in the credit subscription. Accordingly, the quantity of credits can be reissued each time the predetermined validity duration of the credits expires. For example, if the specified start date is May 1, 2011, no end date has been specified, a credit has a predetermined validity duration of one month, and a default subscription duration of six months has been set, then the credit in the credit subscription will be issued on the start date of May 1, 2011 and every month until Nov. 1, 2011, six months later.

However, if a default subscription duration has not been set at step 1914, then at step 1918, the credits service 502 may reissue the quantity of credits on a periodic basis for an indefinite period of time. As in the case of step 1916, the periodic basis may be based on the predetermined validity duration of the credits involved in the credit subscription. The credits may be reissued on the periodic basis until another subscription management message is received that modifies or deletes the credit subscription. The quantity of credits can be reissued each time the predetermined validity duration of the credits expires. For example, if the specified start date is Mar. 1, 2011, no end date has been specified, a credit has a predetermined validity duration of one month, and no default subscription duration has been set, then the credit in the credit subscription will be issued on the start date of Mar. 1, 2011 and every month for an indefinite period of time. In the above description relating to FIG. 19, when credits are issued by the credits service 502, such as at steps 1908, 1910, 1912, 1916, 1918, and 1920, the credits service may store the credits in the credit subscription record for the customer that is stored in the credits database 506.

Returning to FIG. 18, if the customer number and the credit subscription corresponding to the customer exist in the credits database 506 for the customer at step 1808, then the process 1800 continues to step 1810. At step 1810, it is determined whether the subscription lifetime specification denotes a deletion of the credit subscription. A deletion of the credit subscription may be denoted in the subscription lifetime specification by specifying an end date that is before the current date. If the subscription lifetime specification denotes a deletion of the credit subscription, then the credit subscription corresponding to the customer may be deleted at step 1816, such as by calling the CancelSubscription of UpdateSubscriptionExpiration functions. The credit subscription record for the credit subscription corresponding to the customer may be deleted from the credits database 506 to perform the deletion of the credit subscription at step 1816.

If the subscription lifetime specification does not denote a deletion of the credit subscription at step 1810, then at step 1812, it is determined whether the subscription lifetime specification denotes a renewal of the credit subscription. A renewal of the credit subscription may be denoted in the subscription lifetime specification by specifying a start date and/or an end date that is later than the current date. If the subscription lifetime specification denotes a renewal of an existing credit subscription, then the credits service 502 can renew the credit subscription at step 1818 by issuing the quantity of credits in the credit subscription record corresponding to the customer. Step 1818 may be performed by calling the UpdateSubscriptionExpiration function. The credit can be issued starting on the specified start date. If an end date is specified, then the credit in the credit subscription can be valid until the specified end date.

If the subscription lifetime specification does not denote a renewal of the credit subscription at step 1812, then at step 1820, the credit subscription may be modified based on the subscription management message. Modification of the credit subscription may be performed by calling the UpgradeDowngradeSubscription or UpdateSubscriptionExpiration functions. In this case, the subscription package code specified in the subscription management message may differ from an existing subscription code for the customer in the credits database 506. Modification of the credit subscription can include changing the quantity and/or type of credits involved in the credit subscription for the customer. At step 1820, the credit subscription record may be modified by the credits service 502 to issue the quantity of credits as specified by the subscription package code.

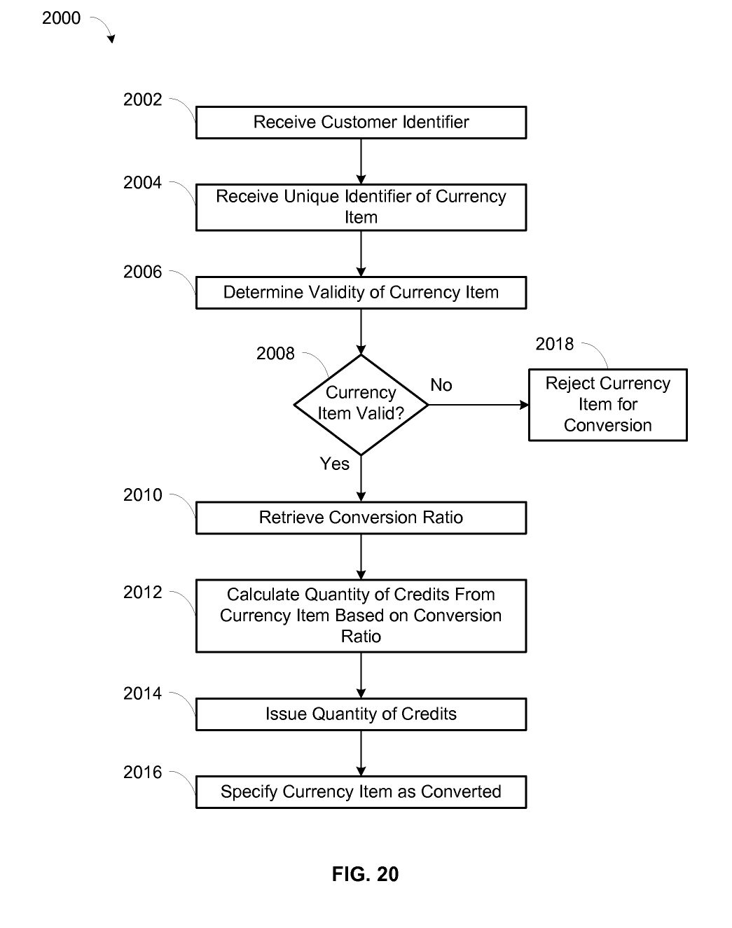

An embodiment of a process 2000 for converting currency items to credits is shown in FIG. 20. The process 2000 can result in the issuance to a customer of a quantity of credits that have been converted from currency items, based on a conversion ratio. The currency items may include coupons, tokens, tickets, points, airline miles, frequent usage incentives, etc. that are issued by an external partner, for example. The credits may be redeemed and/or accrued to satisfy some or all of an initial balance or remaining balance of a variable value transaction, as described above. The variable value transaction may involve a piece of media content. The credits service 502 may perform all or part of the process 2000.

At step 2002, a unique customer identifier may be received from the article dispensing machine 230, the website interface 418, or the A/V display interface 309. The unique customer identifier may include payment card information received at the identification and authentication controller 402, or a customer number corresponding to a particular customer in the customer profile database 404, for example. The customer number may be retrieved from the customer profile database 404 by matching the payment card information to the customer profile, if necessary. At step 2004, unique identifiers of one or more currency items may be received from the article dispensing machine 230, the website interface 418, or the A/V display interface 309. The unique identifiers may be a serial number or other unique numeric, alphabetic, alphanumeric, and/or symbolic identifier of the currency item. In one embodiment, the unique identifiers may be entered through manual input, such as by typing the unique identifiers into the article dispensing machine 230, the website interface 418, or the A/V display interface 309. In other embodiments, the unique identifier may be received by scanning a Universal Product Code or QR code, utilizing near field communication or radio-frequency identification (RFID) tags, or other methodologies. Suitable scanners or readers for receiving the unique identifier may be in communication with the article dispensing machine 230, the website interface 418, or the A/V display interface 309.

The validity of the currency items may be determined at step 2006 based on the received unique identifiers of the currency items. Currency items may be designated as valid if the currency items have not yet been converted into credits. In some embodiments, there may be rules associated with the conversion of currency items, such as a limit on the number of currency items that may be converted into credits, or a restriction on certain types of currency items that may be converted into credits. Conversely, currency items may be designated as invalid if the currency items have already been converted into credits. A mapping file may contain information related to whether a currency item, cataloged by the unique identifier, has already been converted to a credit. The mapping file may be stored in the credits database 506 and processed by the credits service 502 to determine the validity of currency items. In another embodiment, copies of the mapping file may be stored at the article dispensing machines 230, the website interface 418, and/or the A/V display interface 309 so that the validity of currency items can be determined locally, such as when communication with the system backend 307 and credits service 502 is interrupted or cannot be established.

At step 2008, if the currency item is determined as invalid, then the currency item may be rejected for conversion to the credit at step 2018 and the process 2000 is complete. A message may be displayed on the article dispensing machine 230, the website interface 418, or the A/V display interface 309 so that a customer is informed that the currency item is invalid. However, if the currency item is determined as valid at step 2008, then the process 2000 continues to step 2010. At step 2010, a conversion ratio of the currency item to the credit may be retrieved from the credits database 506 or another database. The conversion ratio may dictate the rate at which currency items are converted to credits. For example, the conversion ratio may be one currency unit equal to one credit (1 to 1), fifty currency units equal to one credit (50 to 1), one currency unit equal to ten credits (1 to 10), or any other ratio. At step 2012, the quantity of credits to be issued may be calculated from the number of valid currency items, based on the retrieved conversion ratio. For example, if the conversion ratio is 25 to 1, then 200 valid currency units can be calculated to convert to a quantity of eight credits. As another example, if the conversion ratio is 1 to 5, then five valid currency units can be calculated to convert to a quantity of 25 credits.

The quantity of credits calculated at step 2012 may be issued to the customer at step 2014. The issued credits may be stored in the credits database 506 in an available state 1002 so that the customer may redeem the credits to satisfy an initial balance or remaining balance in a variable value transaction, as described above. The credits may be issued to the customer corresponding to the unique customer identifier received at step 2002, or to the customer number derived from the unique customer identifier. In one embodiment, the issued credits may be designated as conforming to one or more default credit definitions that define the attributes of the credits (e.g., duration, applicable product types, etc.). In another embodiment, the customer may designate one or more credit definitions that the customer wants the issued credits to conform to. In one embodiment, the converted currency items may be deducted from the balance in an account of those currency items that corresponds to the customer. The currency items that have been converted are specified as converted in the mapping file at step 2016. In one embodiment, the unique identifier of the converted currency items may be specified as converted in the mapping file. As described above with reference to steps 2006 and 2008, if currency items have been converted, then the currency items are designated as invalid and cannot later be converted into credits.

To further illustrate the present invention, exemplary implementations of the process 1100 using the credits system 406 for processing a variable value transaction using credits and/or a payment card are described as follows. In the examples, the cutoff time is defined as a predetermined time on a given day by when a customer may return or relinquish access to a rented piece of media content without incurring another rental charge.

In a first example, a customer has four credits applicable to DVDs and Blu-Ray discs and initiates a variable value transaction by renting two Blu-Ray discs at an article dispensing machine 230 on a Monday. Two of the credits can be redeemed for the initial balance of the transaction, corresponding to the rental of the two Blu-Ray discs for Monday night. The initial balance may be $3.00 because the redeemed credits are valued at $1.50 each, for example, since they were used to rent Blu-Ray discs. If the customer returns the two Blu-Ray discs to the article dispensing machine 230 by a cutoff time on Tuesday, then there is no remaining balance and the variable value transaction is complete. However, if the customer does not return the two Blu-Ray discs until Wednesday, then there is a remaining balance for the two Blu-Ray discs for the one extra night of Tuesday night. The two remaining credits may be redeemed for the remaining balance and the payment card does not need to be processed. The remaining balance may be $3.00 because the redeemed credits are valued at $1.50 each. In addition, following the cutoff time on Tuesday, two credits may be accrued and placed in a projected lock state 1004 as predicted to be redeemed for the remaining balance. After the variable value transaction is complete, the customer has no remaining credits in this example.

In a second example, a customer has four credits applicable to DVDs and Blu-Ray discs and initiates a variable value transaction by renting two Blu-Ray discs at an article dispensing machine 230 on a Monday. As in the first example, two of the customer's credits can be redeemed for the initial balance of the transaction, corresponding to the rental of the two Blu-Ray discs for Monday night. The initial balance may be valued at $3.00 because the redeemed credits are valued at $1.50 each, for example, since they were used to rent Blu-Ray discs. In this example, the customer returns one of the Blu-Ray discs to the article dispensing machine 230 by a cutoff time on Tuesday, but keeps the other Blu-Ray disc and also rents two DVDs on Tuesday. The two remaining credits may be redeemed for another initial balance with respect to the two rented DVDs on Tuesday. This initial balance may be $2.00 because the redeemed credits are valued at $1.00 each, for example, since they were used to rent DVDs. The two remaining credits may be applied to the DVDs because the credits system 406 may not yet be aware that a Blu-Ray disc has been returned, and the initial night rental of the DVDs is given priority. At this point, the customer has no credits, so when the second Blu-Ray disc and DVDs are returned to complete the transaction on a future date, the payment card will need to be processed to satisfy the remaining balance.

In a third example, a customer has four credits applicable to DVDs and Blu-Ray discs and initiates a variable value transaction by renting one DVD, one Blu-Ray disc, and one video game disc at an article dispensing machine 230 on a Monday. Two of the credits can be redeemed for the initial balance of the transaction, corresponding to the rental of the DVD and the Blu-Ray disc. The initial balance may be $2.50 because the credit redeemed for the DVD is valued at $1.00 and the credit redeemed for the Blu-Ray disc is valued at $1.50. The payment card can be processed for $2.00 to pay for the initial balance with respect to the video game disc because the customer's credits are not applicable to video game discs. In this example, the customer returns the DVD, Blu-Ray disc, and video game disc by the cutoff time on Thursday. On Tuesday night, two credits may be accrued and placed in a projected lock state 1004 as predicted to be redeemed for the remaining balance for the DVD and Blu-Ray discs. When the transaction is completed on Thursday, the two credits may be redeemed to satisfy the portion of the remaining balance for Tuesday night. However, the payment card will be processed to satisfy the remaining portion of the remaining balance for the video game disc for Tuesday and Wednesday ($2.00 each night), and for the DVD and Blu-Ray disc for Wednesday ($1.00 and $1.50, respectively). The remaining portion satisfied by the payment card will total $6.50 in this example.

In a fourth example, a customer has a $1.00 promotion code and four credits applicable to DVDs and Blu-Ray discs. A variable value transaction is initiated by renting one DVD and two Blu-Ray discs at an article dispensing machine 230 on a Wednesday. The promotion code may be applied to the initial balance prior to redemption of credits. If a rental night for a DVD is valued at $1.00, then the promotion code satisfies the portion of the initial balance with respect to the DVD. Two of the credits may be redeemed for the portion of the initial balance with respect to the two Blu-Ray discs. These credits may be valued at $1.50 each. In this example, the customer returns the DVD and two Blu-Ray discs by the cutoff time on Friday. On Thursday night, two credits may be accrued and placed in a projected lock state 1004 as predicted to be redeemed for the remaining balance for the two Blu-Ray discs. The Blu-Ray discs are given a higher priority because of their higher rental value. When the transaction is completed on Friday, the two credits may be redeemed to satisfy the portion of the remaining balance for the Blu-Ray discs for Thursday night. However, the payment card will be processed to satisfy the remaining portion of $1.00 of the remaining balance for the DVD for Thursday.

In a fifth example, a customer has a $1.00 promotion code and one credit applicable to DVDs and Blu-Ray discs. The customer initiates a variable value transaction by renting one Blu-Ray disc from an article dispensing machine 230 on Saturday. First, the promotion code is applied to the initial balance of $1.50 (the value of a Blu-Ray rental) so that the remaining portion of the initial balance is $0.50. Although the customer has one credit, the credit may not be applied to a balance of less than $1.00, so that the customer retains the credit for later use at a better value. The payment card will be processed for the remaining portion of $0.50 of the initial balance. In this example, the customer returns the Blu-Ray disc by the cutoff time on Tuesday. On Sunday night, one credit may be accrued and placed in a projected lock state 1004 as predicted to be redeemed for the remaining balance for the Blu-Ray disc. When the transaction is completed on Tuesday, the one credit may be redeemed to satisfy the portion of the remaining balance for Sunday night. However, the payment card will be processed to satisfy the remaining portion of $1.50 of the remaining balance for the Blu-Ray disc for Monday.

In a sixth example, a customer initially has two credits applicable to DVDs and Blu-Ray discs, but has a recurring subscription that issues four credits on the first day of every month. The variable value transaction is initiated by renting two DVDs from an article dispensing machine 230 on March 30. The initial balance of $2.00 ($1.00 for each DVD) of the transaction may be satisfied by redeeming the two credits. At this point, the customer has no available credits remaining In this example, the customer returns the DVDs by the cutoff time on April 4. On March 31, a charge of $1.00 for each of the rented DVDs will be incurred but not yet charged because the transaction is still open. On April 1, four credits are issued to the customer's account. Two of these credits may be accrued and placed in a projected lock state 1004 as predicted to be redeemed for the remaining balance for the DVDs for April 1. On April 2, the remaining two credits may be accrued and placed in a projected lock state 1004 as predicted to be redeemed for the remaining balance for the DVDs for April 2. The customer again has no available credits remaining When the transaction is completed on April 4, the four credits may be redeemed to satisfy the portion of the remaining balance for April 1 and April 2. The payment card will be processed to satisfy the remaining portion of $4.00 of the remaining balance for March 31 ($2.00) and April 3 ($2.00).

In a seventh example, a customer has a $1.00 promotion code and one credit applicable only to DVDs. A variable value transaction is initiated by renting one DVD and one Blu-Ray disc from an article dispensing machine 230 on Monday. The promotion code is applied to the initial balance of $2.50 ($1.00 for the DVD and $1.50 for the Blu-Ray disc) so that the remaining portion of the initial balance is $1.50, since the $1.00 portion of the initial balance for the DVD is satisfied by the promotion code. The credit is not applicable to Blu-Ray discs, so the payment card will be processed for the remaining portion of $1.50 of the initial balance. If the customer returns the DVD and Blu-Ray disc by the cutoff time on Tuesday, there is no remaining balance and the transaction is complete.

In an eighth example, a customer has one credit applicable to DVDs and one credit applicable to digital media selections. A variable value transaction is initiated by reserving a DVD and obtaining access to a digital media selection on Monday. The credit applicable to DVDs may be redeemed for the portion of the initial balance with respect to the DVD, and the credit applicable to digital media selections may be redeemed for the other portion of the initial balance with respect to the media selection. The initial balance may be valued at $4.00 because the credits are valued at $1.00 and $3.00, respectively, for the DVD and media selection. If the customer does not pick up the reserved DVD from an article dispensing machine 230, then there is no remaining balance with respect to the DVD. If the customer then relinquishes access to the media selection by the cutoff time on Wednesday, then the remaining balance of $3.00 (for Tuesday night) will be satisfied by processing the payment card.

In a ninth example, a customer has four credits applicable to DVDs and Blu-Ray discs and initiates a variable value transaction by renting one DVD from an article dispensing machine 230 on June 1. The initial balance of $1.00 of the transaction may be satisfied by redeeming one credit, and the customer has three remaining credits at this point. In this example, the customer does not return the DVD and triggers a passive sale of the DVD after a predetermined time period, such as 25 days. Therefore, on June 26, the transaction will be deemed completed. Each of the three remaining credits may be accrued and placed in a projected lock state 1004 as predicted to be redeemed for the remaining balance for the DVD on June 2, 3, and 4, respectively. The three credits may be redeemed on June 26 to satisfy the portion of the remaining balance for June 2, 3, and 4. The payment card will be processed on June 26 for the remaining portion of $21.00 of the remaining balance for June 5-26.

Any process descriptions or blocks in figures should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A method of predicatively accruing a credit in a variable value transaction, wherein the variable value transaction comprises an initial balance and a remaining balance, and the variable value transaction involves a piece of media content, the method comprising:
initiating the variable value transaction;
determining an availability of the credit for the piece of media content, based on an applicability rule of the credit that defines whether the credit is applicable to the piece of media content;
accruing the credit for a predicted redemption of the credit for the remaining balance, if the variable value transaction is not complete and if the credit is available; and
redeeming the credit for the remaining balance upon completion of the variable value transaction, in response to accrual of the credit.

2. The method of claim 1, wherein:
the piece of media content comprises a media article;
initiating the variable value transaction comprises:
satisfying the initial balance; and
vending the media article from an article dispensing machine, in response to satisfying the initial balance; and
the completion of the variable value transaction comprises at least one of a return of the media article to the article dispensing machine, or a passive sale of the media article comprising a non-return of the media article after a predetermined time period.

3. The method of claim 1, wherein:
the piece of media content comprises a media article;
initiating the variable value transaction comprises:
satisfying the initial balance; and
reserving the media article for future pickup from an article dispensing machine, in response to satisfying the initial balance; and
the completion of the variable value transaction comprises at least one of a return of the media article to the article dispensing machine, a passive sale of the media article comprising a non-return of the media article after a predetermined time period, or a non-pickup of the media article from the article dispensing machine.

4. The method of claim 1, wherein:
the piece of media content comprises a media selection;
initiating the variable value transaction comprises:
satisfying the initial balance; and
obtaining access to the media selection at a content provider, in response to satisfying the initial balance; and
the completion of the variable value transaction comprises relinquishing access to the media selection.

5. The method of claim 1, wherein:
accruing the credit comprises transitioning the credit from an available state to a projected lock state; and
redeeming the credit comprises transitioning the credit from the projected lock state to a redeemed state.

6. The method of claim 1, wherein the variable value transaction is stored as a credit cart structure, the method further comprising:
creating an open item in the credit cart structure, in response to initiating the variable value transaction, wherein the open item is for tracking a status of the piece of media content before the completion of the variable value transaction; and
closing the open item in the credit cart structure upon the completion of the variable value transaction.

7. The method of claim 1, wherein a value of the credit for the remaining balance varies depending on one or more parameters of the variable value transaction, the parameters comprising a type of the piece of media content, a location, a date, a time, a promotion code, a tax, a type of the credit, and a source of the credit.

8. The method of claim 1, wherein the remaining balance comprises a first portion and a second portion, and wherein redeeming the credit for the remaining balance comprises:
redeeming the credit for the first portion upon the completion of the variable value transaction, if the credit has been accrued; and
processing a payment card for the second portion upon the completion of the variable value transaction.

9. The method of claim 1, wherein the piece of media content comprises one or more of a media article or a media selection, wherein the media article comprises at least one of a digital video disc, a Blu-Ray disc, or a video game, and the media selection comprises at least one of a video on demand, a streaming video, a downloadable video, a streaming video game, or a downloadable video game.

10. The method of claim 1, wherein redeeming the credit comprises:
determining whether the accrued credit is applicable to the piece of media content, upon the completion of the variable value transaction;
designating the credit as available after accrual of the credit, if the credit is not applicable to the piece of media content; and
redeeming the credit for the remaining balance, if the credit is applicable to the piece of media content.

11. The method of claim 10, wherein designating the credit as available after accrual of the credit comprises transitioning the credit from a projected lock state to an available state.

12. The method of claim 1, further comprising:
determining a pending revenue amount related to the variable value transaction, in response to accruing the credit, wherein the pending revenue amount is based on a source of the credit; and
recognizing the pending revenue amount as a recognized revenue amount, in response to redeeming the credit for the remaining balance.

13. The method of claim 12, wherein determining the pending revenue amount comprises:
adding a value of the credit to the pending revenue amount, in response to accruing the credit; and
excluding the value of the credit from the pending revenue amount, if a customer cannot complete the variable value transaction.

14. A computer readable medium for predicatively accruing a credit in a variable value transaction, wherein the variable value transaction comprises an initial balance and a remaining balance, and the variable value transaction involves a piece of media content, the computer readable medium comprising:
a first code segment for initiating the variable value transaction;
a second code segment for determining an availability of the credit for the piece of media content, based on an applicability rule of the credit that defines whether the credit is applicable to the piece of media content;
a third code segment for accruing the credit for a predicted redemption of the credit for the remaining balance, if the variable value transaction is not complete and if the credit is available; and
a fourth code segment for redeeming the credit for the remaining balance upon completion of the variable value transaction, in response to the third code segment for accruing the credit.

15. The computer readable medium of claim 14, wherein:
the piece of media content comprises a media article;
the first code segment for initiating the variable value transaction comprises:
a fifth code segment for satisfying the initial balance; and
a sixth code segment for vending the media article from an article dispensing machine, in response to the fifth code segment for satisfying the initial balance; and
the completion of the variable value transaction comprises at least one of a return of the media article to the article dispensing machine, or a passive sale of the media article comprising a non-return of the media article after a predetermined time period.

16. The computer readable medium of claim 14, wherein:
the piece of media content comprises a media article;
the first code segment for initiating the variable value transaction comprises:
a seventh code segment for satisfying the initial balance; and
an eighth code segment for reserving the media article for future pickup from an article dispensing machine, in response to the seventh code segment for satisfying the initial balance; and
the completion of the variable value transaction comprises at least one of a return of the media article to the article dispensing machine, a passive sale of the media article comprising a non-return of the media article after a predetermined time period, or a non-pickup of the media article from the article dispensing machine.

17. The computer readable medium of claim 14, wherein:
the piece of media content comprises a media selection;
the first code segment for initiating the variable value transaction comprises:
a ninth code segment for satisfying the initial balance; and
a tenth code segment for obtaining access to the media selection at a content provider, in response to the ninth code segment for satisfying the initial balance; and
the completion of the variable value transaction comprises relinquishing access to the media selection.

18. The computer readable medium of claim 14, wherein:
the third code segment for accruing the credit comprises an eleventh code segment for transitioning the credit from an available state to a projected lock state; and
the fourth code segment for redeeming the credit comprises a twelfth code segment for transitioning the credit from the projected lock state to a redeemed state.

19. The computer readable medium of claim 14, wherein the variable value transaction is stored as a credit cart structure, the computer readable medium further comprising:
a thirteenth code segment for creating an open item in the credit cart structure, in response to the first code segment for initiating the variable value transaction, wherein the open item is for tracking a status of the piece of media content before the completion of the variable value transaction; and
a fourteenth code segment for closing the open item in the credit cart structure upon the completion of the variable value transaction.

20. The computer readable medium of claim 14, wherein a value of the credit for the remaining balance varies depending on one or more parameters of the variable value transaction, the parameters comprising a type of the piece of media content, a location, a date, a time, a promotion code, a tax, a type of the credit, and a source of the credit.

21. The computer readable medium of claim 14, wherein the remaining balance comprises a first portion and a second portion, and wherein the fourth code segment for redeeming the credit for the remaining balance comprises:
a fifteenth code segment for redeeming the credit for the first portion upon the completion of the variable value transaction, if the credit has been accrued; and
a sixteenth code segment for processing a payment card for the second portion upon the completion of the variable value transaction.

22. The computer readable medium of claim 14, wherein the piece of media content comprises one or more of a media article or a media selection, wherein the media article comprises at least one of a digital video disc, a Blu-Ray disc, or a video game, and the media selection comprises at least one of a video on demand, a streaming video, a downloadable video, a streaming video game, or a downloadable video game.

23. The computer readable medium of claim 14, wherein the fourth code segment for redeeming the credit comprises:
a seventeenth code segment for determining whether the accrued credit is applicable to the piece of media content, upon the completion of the variable value transaction;
a eighteenth code segment for designating the credit as available after accrual of the credit, if the credit is not applicable to the piece of media content; and
a nineteenth code segment for redeeming the credit for the remaining balance, if the credit is applicable to the piece of media content.

24. The computer readable medium of claim 23, wherein the eighteenth code segment for designating the credit as available after accrual of the credit comprises a twentieth code segment for transitioning the credit from a projected lock state to an available state.

25. The computer readable medium of claim 14, further comprising:
a twenty-first code segment for determining a pending revenue amount related to the variable value transaction, in response to the third code segment for accruing the credit, wherein the pending revenue amount is based on a source of the credit; and
a twenty-second code segment for recognizing the pending revenue amount as a recognized revenue amount, in response to the fourth code segment for redeeming the credit for the remaining balance.

26. The computer readable medium of claim 25, wherein the twenty-first code segment for determining the pending revenue amount comprises:
a twenty-third code segment for adding a value of the credit to the pending revenue amount, in response to the third code segment for accruing the credit; and
a twenty-fourth code segment for excluding the value of the credit from the pending revenue amount, if a customer cannot complete the variable value transaction.
